(19) United States
(12) Patent Application Publication
(10) Pub. No.: US 2026/0181533 A1
(43) Pub. Date: Jun. 25, 2026

(54) POLAR CODING TECHNIQUES FOR PHYSICAL BROADCAST CHANNEL ENCODING AND TRANSMISSION

(71) Applicant: QUALCOMM Incorporated, San Diego, CA (US)

(72) Inventors: Wei YANG, San Diego, CA (US); Le LIU, San Jose, CA (US); Kirill IVANOV, La Jolla, CA (US); Yan ZHOU, San Diego, CA (US); Jing JIANG, San Diego, CA (US)

(21) Appl. No.: 18/989,818

(22) Filed: Dec. 20, 2024

(51) Int. Cl. H04W 48/16; H04L 1/00; H04W 60/04

(52) U.S. Cl. CPC H04W 48/16; H04L 1/0068; H04W 60/04

(57) ABSTRACT

Methods, systems, and devices for wireless communications are described. A user equipment (UE) may receive, from a first cell, a polar encoded signal including a master information block (MIB) associated with the first cell, the MIB including multiple information bits and a cell barring bit that indicates whether the first cell is available for cell attachment. The polar encoded signal may include a first portion and a second portion. The UE may obtain a value of the cell barring bit based on a comparison between the first portion of the polar encoded signal and the second portion of the polar encoded signal. The UE may decode the polar encoded signal if the cell barring bit indicates that the first cell is available for cell attachment, or may search for another cell if the cell barring bit indicates that the first cell is unavailable for cell attachment.

### FIELD OF TECHNOLOGY

The following relates to wireless communications, including polar coding techniques for physical broadcast channel (PBCH) encoding and transmission.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method by a user equipment (UE) is described. The method may include receiving, from a first cell, a polar encoded signal including a master information block (MIB) associated with the first cell, the MIB including a set of multiple information bits and a cell barring bit that indicates whether the first cell is available for cell attachment, where the polar encoded signal includes a first portion and a second portion, obtaining a value of the cell barring bit based on a comparison between the first portion of the polar encoded signal and the second portion of the polar encoded signal, and decoding the set of multiple information bits of the polar encoded signal based on the value of the cell barring bit indicating that the first cell is available for cell attachment.

A UE is described. The UE may include one or more memories storing processor executable code, and one or more processors coupled with the one or more memories. The one or more processors may individually or collectively be operable to execute the code to cause the UE to receive, from a first cell, a polar encoded signal including a MIB associated with the first cell, the MIB including a set of multiple information bits and a cell barring bit that indicates whether the first cell is available for cell attachment, where the polar encoded signal includes a first portion and a second portion, obtain a value of the cell barring bit based on a comparison between the first portion of the polar encoded signal and the second portion of the polar encoded signal, and decode the set of multiple information bits of the polar encoded signal based on the value of the cell barring bit indicating that the first cell is available for cell attachment.

Another UE is described. The UE may include means for receiving, from a first cell, a polar encoded signal including a MIB associated with the first cell, the MIB including a set of multiple information bits and a cell barring bit that indicates whether the first cell is available for cell attachment, where the polar encoded signal includes a first portion and a second portion, means for obtaining a value of the cell barring bit based on a comparison between the first portion of the polar encoded signal and the second portion of the polar encoded signal, and means for decoding the set of multiple information bits of the polar encoded signal based on the value of the cell barring bit indicating that the first cell is available for cell attachment.

A non-transitory computer-readable medium storing code is described. The code may include instructions executable by one or more processors to receive, from a first cell, a polar encoded signal including a MIB associated with the first cell, the MIB including a set of multiple information bits and a cell barring bit that indicates whether the first cell is available for cell attachment, where the polar encoded signal includes a first portion and a second portion, obtain a value of the cell barring bit based on a comparison between the first portion of the polar encoded signal and the second portion of the polar encoded signal, and decode the set of multiple information bits of the polar encoded signal based on the value of the cell barring bit indicating that the first cell is available for cell attachment.

Some examples of the method, UEs, and non-transitory computer-readable medium described herein may further include operations, features, means, or instructions for monitoring for one or more additional MIBs from one or more additional cells based on the cell barring bit indicating that the first cell may be not available for cell attachment.

Some examples of the method, UEs, and non-transitory computer-readable medium described herein may further include operations, features, means, or instructions for performing a cell attachment procedure based on the cell barring bit indicating that the first cell may be available for cell attachment, and based on decoding the set of multiple information bits of the polar encoded signal.

In some examples of the method, UEs, and non-transitory computer-readable medium described herein, refrain from decoding the set of multiple information bits of the polar encoded signal based on the cell barring bit indicating that the first cell may be not available for cell attachment.

In some examples of the method, UEs, and non-transitory computer-readable medium described herein, the value of the cell barring bit may be obtained based on whether a structure of the first portion of the polar encoded signal and a structure of the second portion of the polar encoded signal may be a same structure.

In some examples of the method, UEs, and non-transitory computer-readable medium described herein, the value of the cell barring bit includes a first value that indicates the first cell may be available for cell attachment based on the structure of the first portion of the polar encoded signal and the structure of the second portion of the polar encoded signal being the same structure and the value of the cell barring bit includes a second value that indicates the first cell may be not available for cell attachment based on the structure of the first portion of the polar encoded signal and the structure of the second portion of the polar encoded signal being different.

In some examples of the method, UEs, and non-transitory computer-readable medium described herein, the polar encoded signal may be encoded in accordance with a MIB format such that that the cell barring bit includes a first bit of the MIB and precedes the set of multiple information bits and decoding the set of multiple information bits of the MIB may be performed based on the MIB format.

Some examples of the method, UEs, and non-transitory computer-readable medium described herein may further include operations, features, means, or instructions for performing a rate de-matching procedure for the polar encoded signal, where the rate de-matching procedure punctures an equal quantity of encoded bits from the first portion of the polar encoded signal and the second portion of the polar encoded signal, and where the comparison between the first portion of the polar encoded signal and the second portion of the polar encoded signal, decoding the set of multiple information bits, or both, may be based on performing the rate de-matching procedure.

Some examples of the method, UEs, and non-transitory computer-readable medium described herein may further include operations, features, means, or instructions for performing a cross-correlation between the first portion of the polar encoded signal and the second portion of the polar encoded signal, where the comparison includes the cross-correlation, and where decoding the set of multiple information bits may be based on a result of the cross-correlation.

In some examples of the method, UEs, and non-transitory computer-readable medium described herein, a first channel index associated with the cell barring bit may be less than N/2 and a set of multiple second channel indexes associated with the set of multiple information bits may be greater than N/2.

In some examples of the method, UEs, and non-transitory computer-readable medium described herein, the set of multiple information bits include a set of multiple MIB bits and a set of multiple cyclic redundancy check (CRC) bits.

In some examples of the method, UEs, and non-transitory computer-readable medium described herein, a length of a polar code associated with the polar encoded signal is 1024.

In some examples of the method, UEs, and non-transitory computer-readable medium described herein, the first portion of the polar encoded signal includes a repetition of the second portion of the polar encoded signal or a bitwise complement of the second portion of the polar encoded signal.

A method by a network entity is described. The method may include encoding a MIB into a polar encoded signal, the MIB including a set of multiple information bits and a cell barring bit that indicates whether a first cell of the network entity is available for cell attachment, where the polar encoded signal includes a first portion and a second portion, transmitting the polar encoded signal based on encoding the MIB, and performing a cell attachment procedure with a UE based on a value of the cell barring bit indicating that the first cell is available for cell attachment.

A network entity is described. The network entity may include one or more memories storing processor executable code, and one or more processors coupled with the one or more memories. The one or more processors may individually or collectively be operable to execute the code to cause the network entity to encode a MIB into a polar encoded signal, the MIB including a set of multiple information bits and a cell barring bit that indicates whether a first cell of the network entity is available for cell attachment, where the polar encoded signal includes a first portion and a second portion, transmit the polar encoded signal based on encoding the MIB, and perform a cell attachment procedure with a UE based on a value of the cell barring bit indicating that the first cell is available for cell attachment.

Another network entity is described. The network entity may include means for encoding a MIB into a polar encoded signal, the MIB including a set of multiple information bits and a cell barring bit that indicates whether a first cell of the network entity is available for cell attachment, where the polar encoded signal includes a first portion and a second portion, means for transmitting the polar encoded signal based on encoding the MIB, and means for performing a cell attachment procedure with a UE based on a value of the cell barring bit indicating that the first cell is available for cell attachment.

A non-transitory computer-readable medium storing code is described. The code may include instructions executable by one or more processors to encode a MIB into a polar encoded signal, the MIB including a set of multiple information bits and a cell barring bit that indicates whether a first cell of the network entity is available for cell attachment, where the polar encoded signal includes a first portion and a second portion, transmit the polar encoded signal based on encoding the MIB, and perform a cell attachment procedure with a UE based on a value of the cell barring bit indicating that the first cell is available for cell attachment.

Some examples of the method, network entities, and non-transitory computer-readable medium described herein may further include operations, features, means, or instructions for generating the MIB in accordance with a MIB format such that that the cell barring bit includes a first bit of the MIB and precedes the set of multiple information bits, where encoding the MIB into the polar encoded signal may be based on the MIB format.

In some examples of the method, network entities, and non-transitory computer-readable medium described herein, to encoding the MIB may include operations, features, means, or instructions for encoding the set of multiple information bits based on a first polar code and encoding the cell barring bit based on performing an xor operation on the second portion of the polar encoded signal and the value of the cell barring bit.

In some examples of the method, network entities, and non-transitory computer-readable medium described herein, the value of the cell barring bit includes a first value that indicates the first cell may be available for cell attachment based on a structure of the first portion of the polar encoded signal and the structure of the second portion of the polar encoded signal being the same structure and the value of the cell barring bit includes a second value that indicates the first cell may be not available for cell attachment based on the structure of the first portion of the polar encoded signal and the structure of the second portion of the polar encoded signal being different.

Some examples of the method, network entities, and non-transitory computer-readable medium described herein may further include operations, features, means, or instructions for performing a rate matching procedure for the polar encoded signal, where the rate matching procedure punctures an equal quantity of encoded bits from the first portion of the polar encoded signal and the second portion of the polar encoded signal, and where encoding the set of multiple information bits may be based on performing the rate matching procedure.

In some examples of the method, network entities, and non-transitory computer-readable medium described herein, a first channel index associated with the cell barring bit may be less than N/2 and a set of multiple second channel indexes associated with the set of multiple information bits may be greater than N/2.

In some examples of the method, network entities, and non-transitory computer-readable medium described herein, the set of multiple information bits include a set of multiple MIB bits and a set of multiple CRC bits.

In some examples of the method, network entities, and non-transitory computer-readable medium described herein, a length of a polar code associated with the polar encoded signal is 1024.

In some examples of the method, network entities, and non-transitory computer-readable medium described herein, the first portion of the polar encoded signal includes a repetition of the second portion of the polar encoded signal or a bitwise complement of the second portion of the polar encoded signal.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports polar coding techniques for physical broadcast channel (PBCH) encoding and transmission in accordance with one or more aspects of the present disclosure.

FIG. 2 shows an example of a wireless communications system that supports polar coding techniques for PBCH encoding and transmission in accordance with one or more aspects of the present disclosure.

FIGS. 3A and 3B show examples of polar encoders that supports polar coding techniques for PBCH encoding and transmission in accordance with one or more aspects of the present disclosure.

FIG. 4 shows an example of a rate matching scheme that supports polar coding techniques for PBCH encoding and transmission in accordance with one or more aspects of the present disclosure.

FIG. 5 shows an example of a process flow that supports polar coding techniques for PBCH encoding and transmission in accordance with one or more aspects of the present disclosure.

FIGS. 6 and 7 show block diagrams of devices that support polar coding techniques for PBCH encoding and transmission in accordance with one or more aspects of the present disclosure.

FIG. 8 shows a block diagram of a communications manager that supports polar coding techniques for PBCH encoding and transmission in accordance with one or more aspects of the present disclosure.

FIG. 9 shows a diagram of a system including a device that supports polar coding techniques for PBCH encoding and transmission in accordance with one or more aspects of the present disclosure.

FIGS. 10 and 11 show block diagrams of devices that support polar coding techniques for PBCH encoding and transmission in accordance with one or more aspects of the present disclosure.

FIG. 12 shows a block diagram of a communications manager that supports polar coding techniques for PBCH encoding and transmission in accordance with one or more aspects of the present disclosure.

FIG. 13 shows a diagram of a system including a device that supports polar coding techniques for PBCH encoding and transmission in accordance with one or more aspects of the present disclosure.

FIGS. 14 through 18 show flowcharts illustrating methods that support polar coding techniques for PBCH encoding and transmission in accordance with one or more aspects of the present disclosure.

### DETAILED DESCRIPTION

In some wireless communications systems, cells may broadcast master information blocks (MIBs) that include information for cell attachment, such as a cell barring bit (e.g., cell bar bit). The cell barring bit may indicate whether the first cell is available for cell attachment. For example, a cell barring bit equal to 0 may indicate that the cell is available for cell attachment, whereas a cell barring bit equal to 1 may indicate that the cell is unavailable for cell attachment. MIBs may be broadcast via a physical broadcast channel (PBCH), which utilizes polar coded signals to broadcast information. To obtain the cell barring bit, the UE may be expected to decode the entire MIB (e.g., decode the entire polar encoded signal), which may increase latency and power consumption at the UE. For instance, in cases where the cell is unavailable for cell attachment (e.g., cell barring bit is 1), the UE may still have to decode the entire polar encoded signal (e.g., decode the entire MIB), even though the UE will not utilize the information in the MIB since the cell is not available for cell attachment.

According to techniques described herein, a UE may quickly and efficiently obtain or decode the cell barring bit of a MIB without decoding the full MIB (e.g., an MIB encoded in a polar encoded signal). For example, the network entity may encode a MIB for a first cell into a polar encoded signal including a first portion and a second portion. The polar encoded signal may indicate the cell barring bit and additional information bits of the MIB (e.g., remaining information bits of the MIB and cyclic redundancy check (CRC) bits). In this regard, the polar encoded signal may exhibit a structure such as [x+c, x], where [x+c] and x are vectors for the first and second portions of the polar encoded signal, respectively, and where c is a vector that conveys the value of the cell barring bit. In some examples, the UE may receive the polar encoded signal, and compare the first portion of the polar encoded signal and the second portions of the polar encoded signal (e.g., compare [x+c] and x) to obtain or decode the value of the cell barring bit (e.g., obtain the value of c). For example, the UE may determine the cell barring bit is 0 (e.g., c=0) if the first portion of the polar encoded signal is the same as the second portion of the polar encoded signal, and the UE may determine the cell barring bit is 1 (e.g., c=1) if the first portion of the polar encoded signal is not the same as the second portion of the polar encoded signal. If the cell barring bit is 1 and the first cell is not available for cell attachment, the UE may stop decoding the polar encoded signal, thus reducing latency and power consumption, among other benefits.

Techniques described herein may enable UEs to determine the value of cell barring bits within polar encoded signals without fully decoding the polar encoded signals. As such, techniques described herein may decrease latency and power consumption at the UE by reducing unnecessary decoding of MIBs for cells that are not available for cell attachment. That is, aspects of the present disclosure may enable UEs to efficiently determine whether or not a cell is available for cell attachment, where the UEs can fully decode a MIB of a polar encoded signal if the cell is available for cell attachment, or search for a new cell (and refrain from fully decoding the MIB).

Aspects of the disclosure are initially described in the context of wireless communications systems. Additional aspects of the disclosure are described in the context of a polar encoder, a rate matching scheme, and a process flow. Aspects of the disclosure are further illustrated by and described with reference to apparatus diagrams, system diagrams, and flowcharts that relate to polar coding techniques for PBCH encoding and transmission.

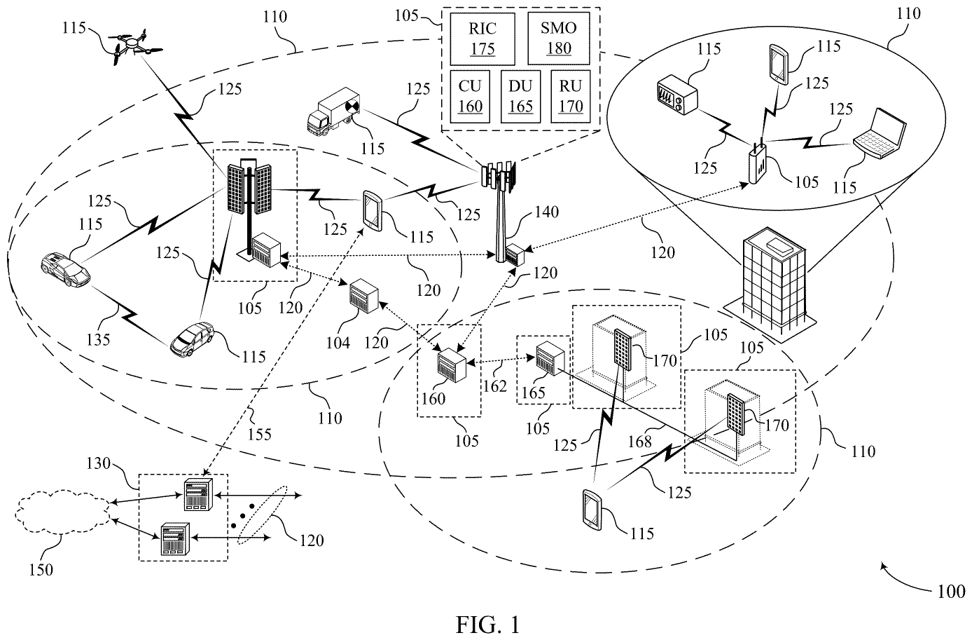

FIG. 1 shows an example of a wireless communications system 100 that supports polar coding techniques for PBCH encoding and transmission in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support polar coding techniques for PBCH encoding and transmission as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

According to techniques described herein, a UE 115 may quickly and efficiently obtain or decode the cell barring bit of a MIB without decoding the full MIB (e.g., an MIB encoded in a polar encoded signal). For example, the network entity 105 may encode a MIB for a first cell into a polar encoded signal including a first portion and a second portion. The polar encoded signal may indicate the cell barring bit and additional information bits of the MIB (e.g., remaining information bits of the MIB and CRC bits). In this regard, the polar encoded signal may exhibit a structure [x+c, x], where [x+c] and x are vectors for the first and second portions of the polar encoded signal, respectively, and where c is a vector that conveys the value of the cell barring bit. In some examples, the UE 115 may receive the polar encoded signal, and compare the first portion of the polar encoded signal and the second portions of the polar encoded signal (e.g., compare [x+c] and x) to obtain or decode the value of the cell barring bit (e.g., obtain the value of c). For example, the UE 115 may determine the cell barring bit is 0 (e.g., c=0) if the first portion of the polar encoded signal is the same as the second portion of the polar encoded signal, and the UE 115 may determine the cell barring bit is 1 (e.g., c=1) if the first portion of the polar encoded signal is not the same as the second portion of the polar encoded signal. If the cell barring bit is 1 and the first cell is not available for cell attachment, the UE 115 may stop decoding the polar encoded signal. Techniques described herein may decrease latency and power consumption at the UE 115 by reducing unnecessary decoding of MIBs for cells that are not available for cell attachment.

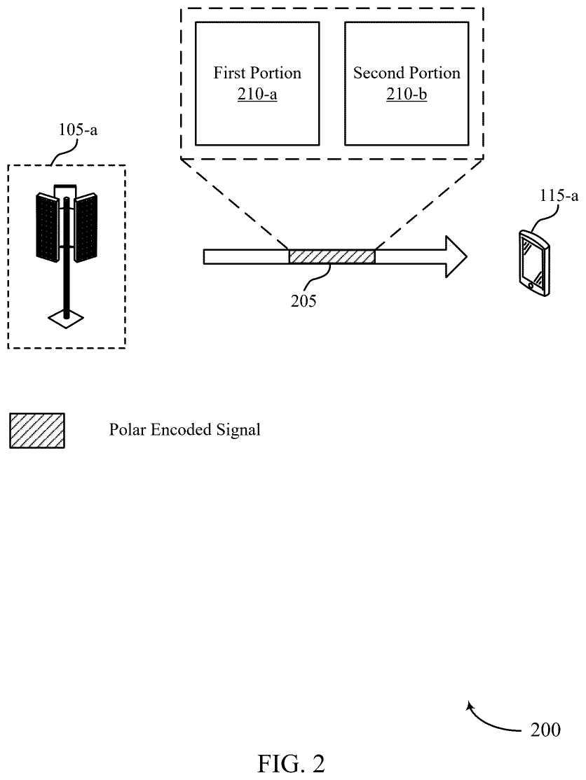

FIG. 2 shows an example of a wireless communications system 200 that supports polar coding techniques for PBCH encoding and transmission in accordance with one or more aspects of the present disclosure.

For example, a UE 115-a may represent an example of a UE, such as the UEs 115 described with reference to FIG. 1. A network entity 105-a may represent an example of a network entity, such as the network entities 105 described with reference to FIG. 1. In this regard, the network entity 105-a may be associated with (e.g., support) one or more serving cells that are accessible by UEs 115 for wireless communications. The network entity 105-a may transmit one or more polar encoded signals 205 to the UE 115-a. The UE 115-a may receive the one or more polar encoded signals 205, and the UE 115-a may decode the polar encoded signals.

In some wireless communications systems, the network entity 105-a may transmit a PBCH payload via a broadcast channel. The PBCH payload may contain MIB information. The UE 115-a may decode and utilize the MIB information to access a cell associated with (e.g., supported by) the network entity 105-a. The MIB information may include one bit indicating whether the cell is barred or forbidden from access or not (e.g., a cell barring bit). For example, the cell barring bit may indicate to the UE 115-a if the UE 115-a is allowed to perform cell attachment with the cell of the network entity 105-a.

In some examples, the cell may be barred (e.g., not accepting new UEs 115) when the cell is serving a threshold quantity of UEs 115 or in communication with a threshold quantity of wireless devices (e.g., fully loaded). Existing UEs 115 in the cell (e.g., radio resource control (RRC) connected UEs 115) may still use the cell. For example, an RRC connected UE 115 served by a barred cell may continue to be served by the barred cell, while new UEs 115 may be barred from performing cell attachment with the barred cell.

In some wireless systems, in order to determine whether or not a cell is available for cell attachment, the UE 115-a may decode the full PBCH payload to determine whether the cell is barred or not. If the cell is barred, then UE 115-a may discard the PBCH and try to access other cells. That is, the UE 115-a may decode the full PBCH payload to determine the value of the cell barring bit. If the cell barring bit indicates the cell of the network entity 105-a is not available for cell attachment (e.g., the cell barring bit is 1), the UE 115-a may nonetheless still decode the full PBCH payload (e.g., decode the entire MIB), even though the UE 115-a will not utilize the information in the MIB since the cell is not available for cell attachment. For example, the UE 115-a may waste energy or time decoding the full PBCH payload for a barred cell.

In some examples, a polar code may be used to encode the PBCH payload. For example, the network entity 105-a may encode the PBCH payload (e.g., MIB information) into a polar encoded signal 205. The polar code may utilize a polarization phenomenon, where after polar transform, a subset of channels may converge to an almost noiseless channel (e.g., almost lossless channel) and a remaining subset of channels may converge to an almost useless channel. The network entity 105-a may transmit information bits or other data via the almost noiseless/lossless channel(s).

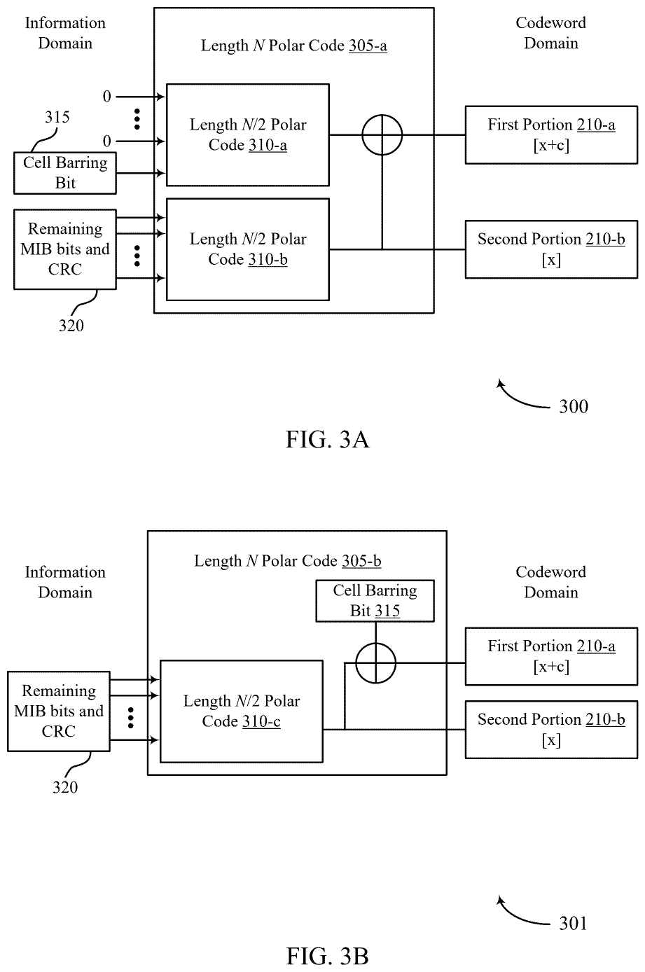

The network entity 105-a may encode the polar code using a recursive structure, where a generator matrix may be a Kronecker product of a 2-by-2 matrix (e.g., [1,0;1,1]). For example, the network entity 105-b may encode information bits in an information domain into codeword bits in a codeword domain using a polar code. In some examples, a second portion 210-b (e.g., a second half) of a polar codeword (e.g., polar encoded signal 205) may be a codeword of a first smaller polar code, and a first portion 210-a (e.g., a first half) of a polar codeword (e.g., polar encoded signal 205) may be a super-position of the two smaller polar codes. For example, the second half of a polar codeword may be a codeword of a smaller polar code, and a first half of a polar codeword may be a super-position of two small polar codes, as described with reference to FIG. 3A.

For example, a polar codeword of a length N polar code may include a first portion 210-a and a second portion 210-b. The network entity 105-a may encode a first set of information bits into a first smaller polar codeword of a length N/2 via a first smaller polar code (e.g., a first length N/2 polar code 310-a as described with reference to FIG. 3A), and the network entity 105-a may encode a second set of information bits into a second smaller polar codeword of the length N/2 via a second smaller polar code (e.g., a second length N/2 polar code 310-b as described with reference to FIG. 3A). The network entity 105-b may perform an exclusive or (XOR) operation on the first smaller polar codeword and the second smaller polar code word to generate the first portion 210-a. The second portion 210-b may be equivalent to the second smaller polar codeword.

The network entity 105-a may transmit the first portion 210-a of the polar encoded signal 205 via one or more first channels (e.g., bit locations), and the network entity 105-a may transmit the second portion 210-b of the polar encoded signal 205 via one or more second channels. The one or more first channels may be within a first range of channel indexes of the first smaller polar code (e.g., 0-255, for N=512), and the one or more second channels may be within a second range of indexes of the second smaller polar code (e.g., 256-511, for N=512). For example, the network entity 105-a may encode a 56-bit PBCH payload (e.g., including CRC) using a polar code of length N=512 such that the polar encoded signal is transmitted via multiple first channels (e.g., {247, 253, 254, 255}), and multiple second channels (e.g., {367, 375, 379, 381, 382, 383, 415, 431, 439, 441, 443, 444, 445, 446, 447, 463, 469, 470, 471, 473, 474, 475, 476, 477, 478, 479 483, 485, 486, 487, 489, 490, 491, 492, 493, 494, 495, 497, 498, 499, 500, 501, 502, 503, 504, 505, 506, 507, 508, 509, 510, 511}).

According to techniques described herein, the UE 115-a may utilize a new PBCH design that enables the UE 115-a to quickly determine whether a cell of the network entity 105-a is barred or not, without decoding the full PBCH payload. For example, the network entity 105 may encode a MIB (e.g., a PBCH payload) for a first cell into a polar encoded signal 205 including a first portion 210-a and a second portion 210-b. The polar encoded signal 205 may indicate the cell barring bit and additional information bits of the MIB (e.g., remaining information bits of the MIB and CRC bits). For example, the network entity 105-a may encode a first vector including a set of zero bits appended with the cell barring bit into a first smaller polar codeword of a length N/2. The network entity 105-a may encode a second vector including the additional information bits of the MIB into a second smaller polar codeword of the length N/2. The network entity 105-a may perform an XOR operation on the first smaller polar codeword and the second smaller polar code word to generate the first portion 210-a. The second portion 210-b may be equivalent to the second smaller polar codeword.

The polar encoded signal 205 may exhibit a structure [x+c, x], where [x+c] is a vector representative of the first portion 210-a of the polar encoded signal 205, and x is a vector representative of the second portion 210-b of the polar encoded signal 205, and where c is a vector that conveys the value of the cell barring bit. In some implementations, the vector x and the vector c may include binary values (e.g., the vector x and the vector c may be binary vectors). The vector [x+c] may be the output of an XOR operation of the vector x and the vector c. For example, x+c may represent the bitwise output of an XOR operation performed on corresponding entries in the vector x and the vector c.

In some examples, the UE 115 may receive the polar encoded signal 205, and compare the first portion 210-a and the second portion 210-b (e.g., compare [x+c] and x) to obtain or decode the value of the cell barring bit (e.g., obtain the value of c). For example, the UE 115 may determine the cell barring bit is 0 if the first portion 210-a of the polar encoded signal 205 is the same (or similar) as the second portion 210-b of the polar encoded signal 205, and the UE 115 may determine the cell barring bit is 1 if the first portion 210-a is not the same as the second portion 210-b. If the cell barring bit is 1 (e.g., the first cell is not available for cell attachment), the UE 115 may stop decoding the polar encoded signal 205. Techniques described herein may decrease latency and power consumption at the UE 115 by reducing unnecessary decoding of MIBs for cells that are not available for cell attachment.

FIG. 3A show example of a polar encoder 300 that supports polar coding techniques for PBCH encoding and transmission in accordance with one or more aspects of the present disclosure. In some examples, polar encoder 300 may implement aspects of wireless communications system 100 and wireless communications system 200. For example, the polar encoder 300 may be implemented by a network entity 105, as described with reference to FIGS. 1 and 2, to encode MIB information into a polar encoded signal (e.g., polar encoded signal 205).

The network entity 105 may generate a MIB indicating information for a cell attachment procedure. The network entity 105 may encode the MIB into a polar encoded signal using a length N polar code 305-a. The length N polar code 305-a may include multiple smaller polar codes (e.g., a first length N/2 polar code 310-a and a second length N/2 polar code 310-b). For example, the network entity 105 may encode input bits of an information domain into a codeword of a codeword domain. The input bits may include an upper half encoded using the first length N/2 polar code 310-a and a lower half encoded using the second length N/2 polar code 310-b. The network entity 105 may place a cell barring bit 315 (e.g., a cell barring bit 315 of a MIB) in a last bit of the upper half (e.g., the upper half encoded by the first N/2 polar code 310-a or subcode) of the polar code.

For example, the upper half of the polar code (e.g., length N/2 polar code 310-a0 may be a first half of the polar code in the information domain and codeword domain. For example, as part of a polar encoding procedure, the network entity 105 may generate an vector of information bits (e.g., [a0, a1, . . . , aN−1]), and the network entity 105 may map the vector of information bits to the length N polar code 305-a. For instance, a first half of the information bits (e.g., [a0, . . . , aN/2−1] or a first half of the input), may be mapped to the upper half of the polar transform or polar code (e.g., the first length N/2 polar code 310-a), and the second half of the information bits (e.g., [aN/2, . . . , aN-1] or a second half of the input) may be mapped to the bottom half of the polar transform (e.g., the second length N/2 polar code 310-b).

The network entity 105 may encode the cell barring bit 315 as the first bit of the MIB to be transmitted to the UE 115 via the polar encoded signal. For example, the MIB content may be represented as a vector of bits [a0, a1, . . . , aK−1], where K may denotes a total quantity of MIB bits, and where first bit (e.g., a0) may include the cell barring bit 315. The network entity 105 may place the remaining MIB bits and CRC 320 in corresponding information bit locations of a lower half (e.g., the lower half encoded by the second N/2 polar code 310-b or subcode).

The cell barring bit 315 may be a first or initial bit in the MIB content. The network entity 105 may select a single information bit (e.g., the cell barring bit 315) from the first half of the polar sequence (e.g., the first codeword), and the network entity may select K−1 information bits from the remaining half of the polar sequence (e.g., the second codeword), where K denotes a total payload of a PBCH including CRC.

The network entity 105 may encode the cell barring bit 315 and the remaining MIB bits and CRC 320 into a polar encoded signal (e.g., a polar sequence) including a first portion 210-a and a second portion 210-b, as described with reference to FIG. 2. For example, the network entity may perform an XOR operation on a first codeword output from the first length N/2 polar code 310-a and a second codeword output from the second length N/2 polar code 310-b to generate the first portion 210-a. The second portion 210-b may be the second codeword output from the second length N/2 polar code 310-b.

The network entity 105 may transmit the polar encoded signal via one or more channels associated with the length N polar code 305-a. A bit location (e.g., channel) of the cell barring bit 315 may be a last bit location or channel in a first half of channels (e.g., channels used by the first length N/2 polar code 310-a). The last channel may be associated with the channel index N/2-1, where a starting index is 0.

The network entity 105 may select the bit locations to map the information bits (e.g., cell barring bit 315, remaining MIB bits and CRC 320) to a polar code, where the network entity 105 may select 1 bit from the first N/2 bit locations (e.g., positions), and select K−1 bit position from the second N/2 bit locations. Stated differently, the information bits (e.g., MIB information to be communicated to the UE 115-a) may be mapped to a set of information bit locations associated with a length-N polar code. The rest of the information bit locations that are not used (e.g., not mapped to the information bits) may be set to be frozen bits/zero bits. In particular, in accordance with aspects of the present disclosure, the network entity 105-a may select the information bit locations to map the information bits to a polar code, and may select only 1 bit (e.g., cell barring bit 315) from the first N/2 positions, and select K−1 information bits from the remaining N/2 information bit positions.

For example, the network entity 105-a may map the information bits (e.g., the 56-bit PBCH payload) to a set of information bit locations associated with a length-N polar code 305-a. The network entity 105-a may select bit locations associated with a polar code of length N=512 for a 56-bit PBCH payload (e.g., multiple information bits) such that an initial bit of the 56-bit PBCH payload is mapped to a single first channel or a single bit location from the first N/2 bit locations (e.g., {255}), and a set of remaining bits of the 56-bit PBCH payload is mapped to multiple second channels or multiple second bit locations from the second N/2 bit locations (e.g., {367, 375, 379, 381, 382, 383, 415, 431, 438, 439, 441, 442, 443, 444, 445, 446, 447, 462, 463, 469, 470, 471, 473, 474, 475, 476, 477, 478, 479, 483, 485, 486, 487, 489, 490, 491, 492, 493, 494, 495, 497, 498, 499, 500, 501, 502, 503, 504, 505, 506, 507, 508, 509, 510, 511}). A remaining set of bit locations that may not be used may be set to frozen bits or zero bits.

For example, the network entity 105-a may transmit the polar encoded signal via a single channel or bit location with an index below N/2 (e.g., 256 for N=512 or on the upper half of polar code). The network entity 105-a may utilize one or more additional channel indices above N/2 (e.g., 256 for N=512 or on the lower half of polar code). The cell barring bit 315 may be placed on an index of 255 of the length-512 polar code (e.g., where index starts with 0).

The output from the polar code (e.g., before rate-matching) may have the structure [x+c, x], where x is a binary vector (e.g., of size N/2). For example, as shown in FIG. 3A, the first portion 210-a of the polar encoded signal may have a structure [x+c], and the second portion 210-b of the polar encoded signal may have a structure [x]. The vector x may contain the second half of the codeword (e.g., the second portion 210-b), and c may be a vector including multiple 0 bits or multiple 1 bits. The vector c may convey the value of the cell barring bit 315. For example, as follows c may be a vector of all 0 bits (e.g., c=[0, . . . , 0]) if the cell barring bit 315 is 0 (indicating that the cell is available for cell attachment), or c may be a vector of all 1 bits (e.g., c=[1, . . . , 1]) if the cell barring bit 315 is 1 (indicating that the cell is unavailable for cell attachment). The structure may enable a simplified decoder as described herein.

For example, a wireless device receiving the polar encoded signal (e.g., a receiver or the UE 115) may compare the first portion 210-a of the received signal with the second portion 210-b of the received signal (e.g., after de-rate matching). The receiver may decode the cell barring bit 315 by comparing the first portion 210-a and the second portion 210-b.

For instance, the receiver may determine the cell barring bit 315 is 0 (e.g., c=[0, . . . , 0]) if the first portion 210-a is the same as the second portion 210-b, and the receiver may determine the cell barring bit 315 is 1 (e.g., c=[1, . . . , 1]) if the first portion 210-a is not the same as the second portion 210-b. If the cell barring bit 315 is 0 (indicating that the cell is available for cell attachment), the receiver may continue to decode the remaining PBCH content (e.g., by softly combining the first portion 210-a and the second portion 210-b of the signal). If the cell barring bit 315 is 1 (indicating that the cell is unavailable for cell attachment), the receiver may stop the decoding (e.g., since the cell is barred).

The techniques described herein may enable power saving at the receiver (e.g., the UE 115). For example, since most of PBCH decoding is false PBCHs, by reducing the quantity of decodes performed based on the cell barring bit 315, UEs 115 may be able to refrain from decoding the PBCH payload in some instances, which may result in power saving for PBCH decoding. For example, techniques described herein may enable UEs 115 to refrain from decoding 50% of PBCHs (for cells that are unavailable for cell attachment), thereby providing ˜50% power saving on PBCH decoding.

Moreover, when the cell is not barred, the receiver may effectively decode a length N/2 polar code, instead of a length N polar code 305-a. The reduced polar code size may further reduce complexity (e.g., decoder hardware complexity). For example, an area of the decoder hardware used to implement the polar decoder may be reduced based on the reduced polar code size. For instance, a length-N/2 polar decoder may occupy half the hardware area as a length N polar decoder in hardware implementation, thereby reducing cost/complexity of the hardware, and reducing power consumption of the hardware. That is, when the cell is not barred, the UE 115 may decode the second portion 210-b of the polar encoded signal (which is encoded with length N/2 polar code 310-b) in order to decode the rest of the MIB information that will be used to access the cell (instead of decoding the full polar encoded signal that is encoded with length N polar code 305-a).

The structure of the polar code (e.g., [x+c, x]) may enable the UE 115 to prune false PBCH candidates (e.g., prune or ignore PBCHs for cells that are unavailable for cell attachment) without invoking the polar decoder. The UE 115 (e.g., the receiver) may test whether a received signal has the repetition structure [x+c, x] or not (e.g., by comparing the first portion 210-a and the second portion 210-b). Based on the structure test, the UE 115 may determine whether the received signal corresponds to a valid PBCH candidate (e.g., regardless of the value of the cell barring bit 315). For example, the UE 115 may perform a cross-correlation between the first portion 210-a and the second portion 210-b. The UE 115 may compare the absolute value of the correlation against a threshold. If the correlation is larger than a threshold, then a received signal may be more likely to correspond to a valid PBCH candidate (e.g., whether the PBCH candidate exhibits repetition structure [x+c, x]). For example, the UE 115 may calculate the correlation in accordance with Equation 1.

$$Corr = \vert < {y}_{0}^{\frac{N}{2} - 1} , {y}_{\frac{N}{2}}^{N - 1} > \vert \qquad ( 1 )$$

where Corr indicates a correlation metric of the first portion 210-a and the second portion 210-b of the polar encoded signal, N is the length of the polar code, and where

$${y}_{0}^{\frac{N}{2} - 1} and {y}_{\frac{N}{2}}^{N - 1}$$

represent the first portion 210-a and the second portion 210-b, respectively.

In some examples, a PBCH payload may include 864 encoded bits, which may be obtained from a length-N=512 polar code with repetition (e.g., repeating 352 bits). The length-N=512 polar code may reduce the UE decoder complexity (e.g., the UE 115 may implement a length-N=512 polar code, instead of a length N=1024 polar code). As described herein, since the network entity 105 may add one bit (e.g., the cell barring bit 315) in the upper half of polar code (e.g., the upper half encoded by the first length N/2 polar code 310-a), the UE 115 may not implement a length N polar decoder. For example, the UE 115 may efficiently decode the polar encoded signal using a length-N/2 polar decoder.

The network entity 105 and the UE 115 may utilize a length N=1024 polar code for PBCH. As described herein, the UE 115 may be implement a length-N/2 (e.g., N/2=512) polar decoder to decode the remaining MIB bits and CRC 320. The techniques described herein may provide for decreased decoder complexity and increased power saving.

FIG. 3B show example of a polar encoder 301 that supports polar coding techniques for PBCH encoding and transmission in accordance with one or more aspects of the present disclosure. In some examples, polar encoder 301 may implement aspects of wireless communications system 100, wireless communications system 200, or polar encoder 300. For example, the polar encoder 300 may be implemented by a network entity 105 (e.g., as described with reference to FIGS. 1 and 2) to encode MIB information into a polar encoded signal.

In additional or alternative implementations, as shown in FIG. 3B, the network entity 105 may use a length-N/2 polar code to encode the remaining MIB bits and CRC 320 (e.g., excluding the cell barring bit 315) to generate the second portion 210-b (e.g., x). The network entity 105-b may generate the first portion 210-a (e.g., x+c) based on the value of the cell barring bit 315. For example, the length N polar code 305-b may include a length N/2 polar code 310-c. The network entity may encode the remaining MIB bits and CRC 320 into a codeword (e.g., x). The second portion 210-b may be equivalent to the codeword. The network entity 105 may perform a bitwise XOR operation on the codeword and the cell barring bit 315. The final signal for the polar encoded signal (e.g., PBCH) may be [x+c, x]. That is, the end result of the polar encoder 300 in FIG. 3A and the polar encoder 301 in FIG. 3B may be the same.

The network entity 105-b may compute CRC bit included in the remaining MIB bits and CRC 320. In some examples, the CRC bits may be computed based on both the cell barring bit 315 and the remaining MIB bits (e.g., the remaining MIB bits included in the remaining MIB bits and CRC 320). In other examples, the CRC bits may be computed based on the remaining MIB bits, but not based on cell barring bit 315.

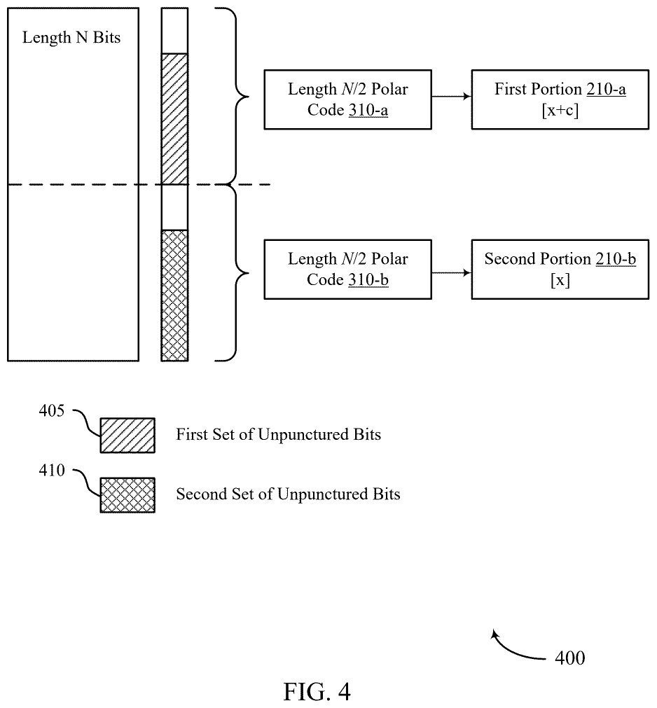

FIG. 4 shows an example of a rate matching scheme 400 that supports polar coding techniques for PBCH encoding and transmission in accordance with one or more aspects of the present disclosure. In some examples, rate matching scheme 400 may implement aspects of wireless communications system 100, wireless communications system 200, polar encoder 300, or polar encoder 301. For example, the rate matching scheme 400 may be implemented by a network entity 105 (e.g., as described with reference to FIGS. 1 and 2) to puncture one or more bits of a polar encoded signal. Similarly, a UE 115 may perform de-rate matching based on the rate matching performed by the network entity 105.

In some examples, the network entity 105 may puncture one or more bits of a message based on a coding rate. Rate-matching may refer to the procedure of converting a length-N (e.g., where N is power of 2) polar codeword into a length M polar codeword (e.g., where M is not power of 2). In some examples, a rate matching scheme may ignore the rate matching of polar codes. For example, a rate matching pattern for PBCH may puncture a subset of bits from one half of the polar codeword and keep a remaining half of the polar codeword untouched. That is, the rate matching pattern may puncture one or more bits from the first portion 210-a of the polar encoded signal, and the rate matching pattern may not puncture one or more bits from the second portion 210-b of the polar encoded signal. When correlation is performed to decode the cell barring bit, the UE 115 may correlate the shorter, punctured signal with a latter part of the longer signal. For example, if 160 bits are punctured for a length N=512 polar code, a length of the shorter, punctured signal may be 352 and a length of the unpunctured signal may be 512. The puncturing may reduce the reliability of decoding the cell barring bit (e.g., since the UE 115 use 352 bits for the correlation).

According to techniques described herein, for rate matching for PBCH, the network entity 105 may perform equal puncturing (e.g., or repetition) of the two portions of the length-N polar code. For example, if 160 bits are punctured for a length N=512 polar code, the UE 115 may use 432 bits from each of the first portion 210-a and second portion 210-b of the polar code for PBCH or correlation.

For example, the network entity 105 may puncture a first subset of bits from the first portion 210-a generating a first set of unpunctured bits 405. The network entity 105 may puncture a second subset of bits from the second portion 210-b generating a second set of unpunctured bits 410. The first set of unpunctured bits 405 and the second set of unpunctured bits 410 may include a same quantity of bits. For example, for a polar encoded signal of the structure [x+c, x], the length of x+c and x may both be a same length (e.g., 432 bits, if 160 bits are punctured for a length N=512 polar code).

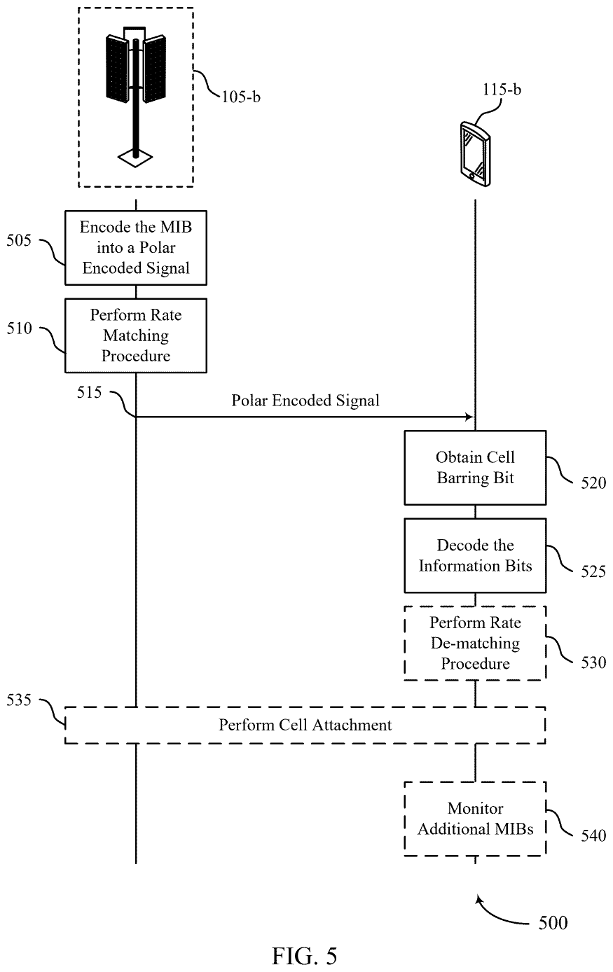

FIG. 5 shows an example of a process flow 500 that supports polar coding techniques for PBCH encoding and transmission in accordance with one or more aspects of the present disclosure. In some examples, process flow 500 may implement aspects of wireless communications system 100, wireless communications system 200, polar encoder 300, polar encoder 301, or rate matching scheme 400. For example, the process flow 500 may include a UE 115-b and a network entity 105-b which may be examples of corresponding devices described with reference to FIGS. 1-2.

The network entity 105-b may generate a MIB in accordance with a MIB format such that that the cell barring bit includes a first bit of the MIB and precedes multiple information bits (e.g., the remaining MIB bits and CRC 320 as described with reference to FIGS. 3A and 3B). The multiple information bits may include multiple MIB bits and multiple CRC bits.

At 505, the network entity 105-b may encode the MIB (e.g., a PBCH payload) into a polar encoded signal, the MIB may include multiple information bits and a cell barring bit that indicates whether a first cell of the network entity is available for cell attachment. The polar encoded signal may include a first portion and a second portion (e.g., the first portion 210-a or the second portion 210-b as described with reference to FIGS. 2-4). In some cases, encoding the MIB into the polar encoded signal may be based on the MIB format.

In some cases, the network entity 105-b may encode the multiple information bits based on a first polar code, and the network entity 105-b may encode the cell barring bit based on performing an XOR operation on the second portion of the polar encoded signal and the value of the cell barring bit.

In some cases, the first portion of the polar encoded signal may include a repetition of the second portion of the polar encoded signal or a bitwise complement of the second portion of the polar encoded signal.

In some cases, the cell barring bit and the multiple information bits may be jointly encoded using a polar code of length N. A first channel index associated with the cell barring bit may be less than N/2, and multiple second channel indexes associated with the plurality of information bits may be greater than N/2. A length of a polar code associated with the polar encoded signal may be 1024.

At 510, the network entity 105-b may perform a rate matching procedure for the polar encoded signal (e.g., as described with reference to FIG. 4). The rate matching procedure may puncture an equal quantity of encoded bits from the first portion of the polar encoded signal and the second portion of the polar encoded signal. Encoding the plurality of information bits may be based on performing the rate matching procedure.

At 515, the UE 115-b may receive, from a first cell, the polar encoded signal including the MIB associated with the first cell. For example, the network entity 105-b may the polar encoded signal based on encoding the MIB.

At 520, the UE 115-b may obtain a value of the cell barring bit based on a comparison between the first portion of the polar encoded signal and the second portion of the polar encoded signal. In some cases, the value of the cell barring bit may be obtained based on whether a structure of the first portion of the polar encoded signal and a structure of the second portion of the polar encoded signal are a same structure.

In some cases, the value of the cell barring bit may include a first value that indicates the first cell is available for cell attachment based on the structure of the first portion of the polar encoded signal and the structure of the second portion of the polar encoded signal being the same structure. In some cases, the value of the cell barring bit may include a second value that indicates the first cell is not available for cell attachment based on the structure of the first portion of the polar encoded signal and the structure of the second portion of the polar encoded signal being different.

In some cases, at 525, the UE 115-b may decode the multiple information bits of the polar encoded signal based on the value of the cell barring bit indicating that the first cell is available for cell attachment. In some cases, at 525, the UE 115-b may refrain from decoding the multiple information bits of the polar encoded signal based on the cell barring bit indicating that the first cell is not available for cell attachment. In some cases, decoding the multiple information bits of the MIB may be performed based on the MIB format.

At 530, the UE 115-b may perform a rate de-matching procedure for the polar encoded signal (e.g., as shown in FIG. 4). The rate de-matching procedure may puncture an equal quantity of encoded bits from the first portion of the polar encoded signal and the second portion of the polar encoded signal. The comparison between the first portion of the polar encoded signal and the second portion of the polar encoded signal, decoding the multiple information bits, or both, may be based on performing the rate de-matching procedure.

In some cases, the UE 115-b may perform a cross-correlation between the first portion of the polar encoded signal and the second portion of the polar encoded signal. The comparison may include the cross-correlation and decoding the multiple information bits may be based on a result of the cross-correlation.

At 535, the UE 115-b and the network entity 105-b may performing a cell attachment procedure based on the cell barring bit indicating that the first cell is available for cell attachment, and based on decoding the multiple information bits of the polar encoded signal.

At 540, the UE 115-b may monitor for one or more additional MIBs from one or more additional cells based on the cell barring bit indicating that the first cell is not available for cell attachment.

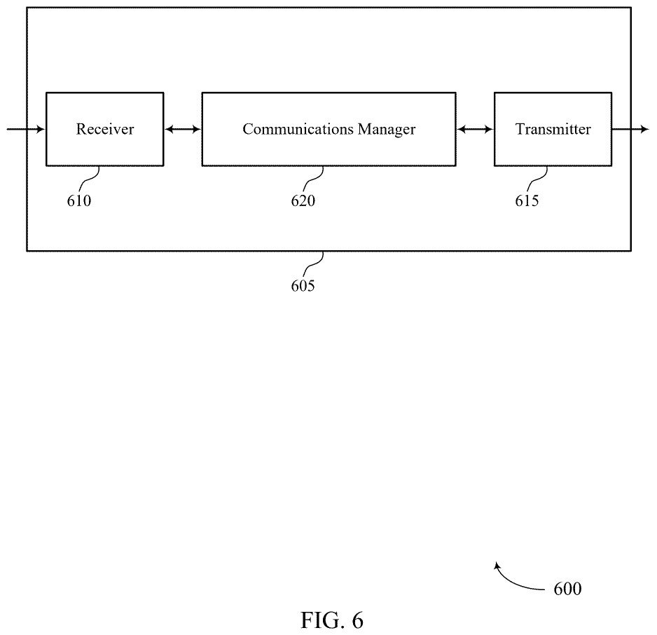

FIG. 6 shows a block diagram 600 of a device 605 that supports polar coding techniques for PBCH encoding and transmission in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to polar coding techniques for PBCH encoding and transmission). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to polar coding techniques for PBCH encoding and transmission). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of polar coding techniques for PBCH encoding and transmission as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving, from a first cell, a polar encoded signal including a MIB associated with the first cell, the MIB including a set of multiple information bits and a cell barring bit that indicates whether the first cell is available for cell attachment, where the polar encoded signal includes a first portion and a second portion. The communications manager 620 is capable of, configured to, or operable to support a means for obtaining a value of the cell barring bit based on a comparison between the first portion of the polar encoded signal and the second portion of the polar encoded signal. The communications manager 620 is capable of, configured to, or operable to support a means for decoding the set of multiple information bits of the polar encoded signal based on the value of the cell barring bit indicating that the first cell is available for cell attachment.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing, reduced power consumption, more efficient utilization of communication resources, and the like.

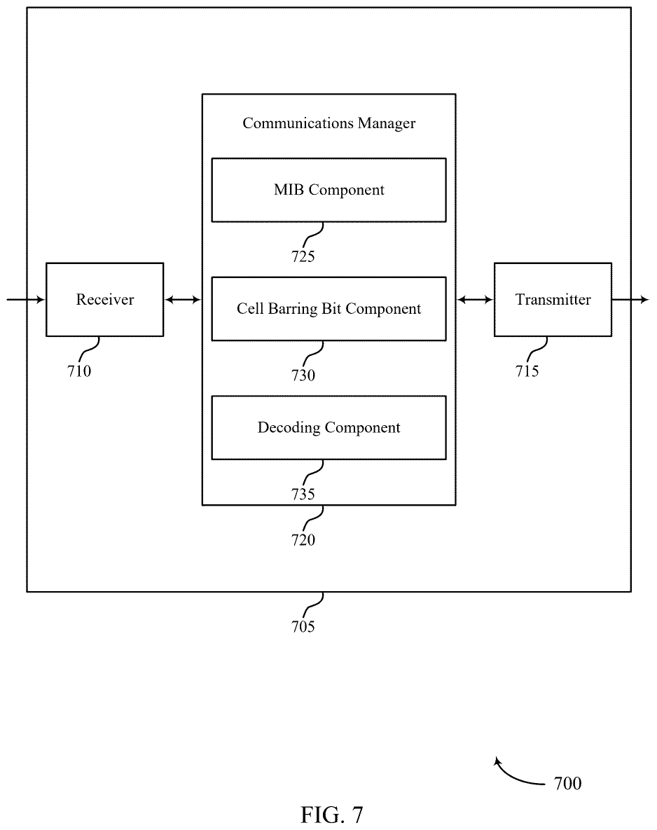

FIG. 7 shows a block diagram 700 of a device 705 that supports polar coding techniques for PBCH encoding and transmission in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to polar coding techniques for PBCH encoding and transmission). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to polar coding techniques for PBCH encoding and transmission). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of polar coding techniques for PBCH encoding and transmission as described herein. For example, the communications manager 720 may include a MIB component 725, a cell barring bit component 730, a decoding component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The MIB component 725 is capable of, configured to, or operable to support a means for receiving, from a first cell, a polar encoded signal including a MIB associated with the first cell, the MIB including a set of multiple information bits and a cell barring bit that indicates whether the first cell is available for cell attachment, where the polar encoded signal includes a first portion and a second portion. The cell barring bit component 730 is capable of, configured to, or operable to support a means for obtaining a value of the cell barring bit based on a comparison between the first portion of the polar encoded signal and the second portion of the polar encoded signal. The decoding component 735 is capable of, configured to, or operable to support a means for decoding the set of multiple information bits of the polar encoded signal based on the value of the cell barring bit indicating that the first cell is available for cell attachment.

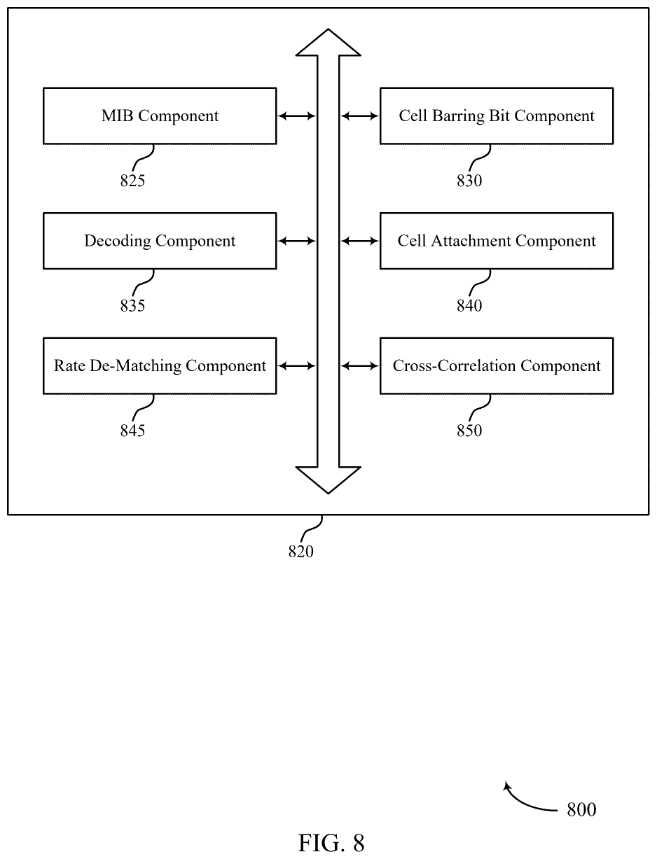

FIG. 8 shows a block diagram 800 of a communications manager 820 that supports polar coding techniques for PBCH encoding and transmission in accordance with one or more aspects of the present disclosure. The communications manager 820 may be an example of aspects of a communications manager 620, a communications manager 720, or both, as described herein. The communications manager 820, or various components thereof, may be an example of means for performing various aspects of polar coding techniques for PBCH encoding and transmission as described herein. For example, the communications manager 820 may include a MIB component 825, a cell barring bit component 830, a decoding component 835, a cell attachment component 840, a rate de-matching component 845, a cross-correlation component 850, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The MIB component 825 is capable of, configured to, or operable to support a means for receiving, from a first cell, a polar encoded signal including a MIB associated with the first cell, the MIB including a set of multiple information bits and a cell barring bit that indicates whether the first cell is available for cell attachment, where the polar encoded signal includes a first portion and a second portion. The cell barring bit component 830 is capable of, configured to, or operable to support a means for obtaining a value of the cell barring bit based on a comparison between the first portion of the polar encoded signal and the second portion of the polar encoded signal. The decoding component 835 is capable of, configured to, or operable to support a means for decoding the set of multiple information bits of the polar encoded signal based on the value of the cell barring bit indicating that the first cell is available for cell attachment.

In some examples, the MIB component 825 is capable of, configured to, or operable to support a means for monitoring for one or more additional MIBs from one or more additional cells based on the cell barring bit indicating that the first cell is not available for cell attachment.

In some examples, the cell attachment component 840 is capable of, configured to, or operable to support a means for performing a cell attachment procedure based on the cell barring bit indicating that the first cell is available for cell attachment, and based on decoding the set of multiple information bits of the polar encoded signal.

In some examples, the decoding component 835 is capable of, configured to, or operable to support a means for refraining from decoding the set of multiple information bits of the polar encoded signal based on the cell barring bit indicating that the first cell is not available for cell attachment.

In some examples, the value of the cell barring bit is obtained based on whether a structure of the first portion of the polar encoded signal and a structure of the second portion of the polar encoded signal are the same structure.

In some examples, the value of the cell barring bit includes a first value that indicates the first cell is available for cell attachment based on the structure of the first portion of the polar encoded signal and the structure of the second portion of the polar encoded signal being the same structure. In some examples, the value of the cell barring bit includes a second value that indicates the first cell is not available for cell attachment based on the structure of the first portion of the polar encoded signal and the structure of the second portion of the polar encoded signal being different.

In some examples, the polar encoded signal is encoded in accordance with a MIB format such that that the cell barring bit includes a first bit of the MIB and precedes the set of multiple information bits. In some examples, decoding the set of multiple information bits of the MIB is performed based on the MIB format.

In some examples, the rate de-matching component 845 is capable of, configured to, or operable to support a means for performing a rate de-matching procedure for the polar encoded signal, where the rate de-matching procedure punctures an equal quantity of encoded bits from the first portion of the polar encoded signal and the second portion of the polar encoded signal, and where the comparison between the first portion of the polar encoded signal and the second portion of the polar encoded signal, decoding the set of multiple information bits, or both, is based on performing the rate de-matching procedure.

In some examples, the cross-correlation component 850 is capable of, configured to, or operable to support a means for performing a cross-correlation between the first portion of the polar encoded signal and the second portion of the polar encoded signal, where the comparison includes the cross-correlation, and where decoding the set of multiple information bits is based on a result of the cross-correlation.

In some examples, a first channel index associated with the cell barring bit is less than N/2. In some examples, a set of multiple second channel indexes associated with the set of multiple information bits are greater than N/2.

In some examples, the set of multiple information bits include a set of multiple master information block bits and a set of multiple CRC bits.

In some examples, a length of a polar code associated with the polar encoded signal is 1024.

In some examples, the first portion of the polar encoded signal includes a repetition of the second portion of the polar encoded signal or a bitwise complement of the second portion of the polar encoded signal.

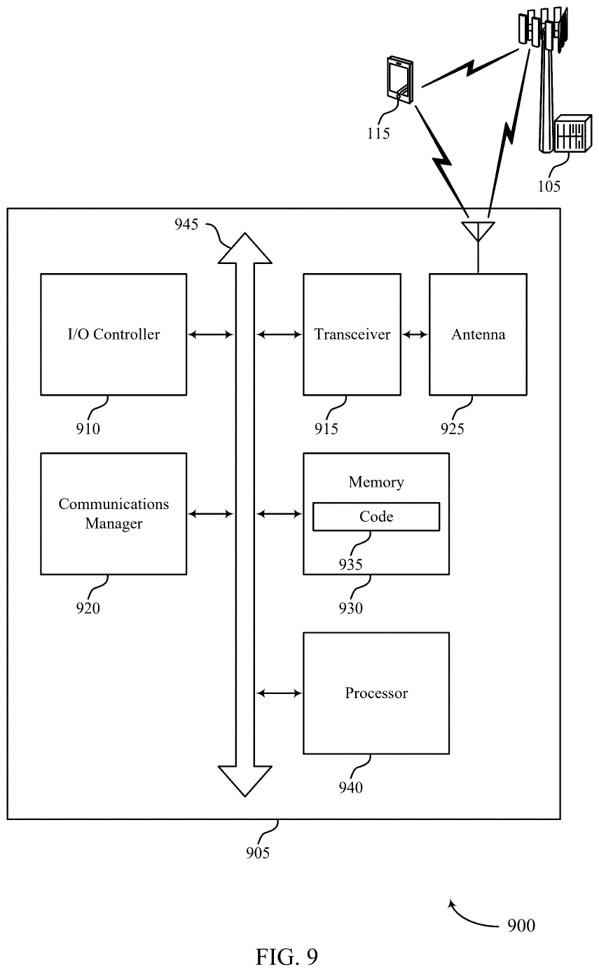

FIG. 9 shows a diagram of a system 900 including a device 905 that supports polar coding techniques for PBCH encoding and transmission in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting polar coding techniques for PBCH encoding and transmission). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving, from a first cell, a polar encoded signal including a MIB associated with the first cell, the MIB including a set of multiple information bits and a cell barring bit that indicates whether the first cell is available for cell attachment, where the polar encoded signal includes a first portion and a second portion. The communications manager 920 is capable of, configured to, or operable to support a means for obtaining a value of the cell barring bit based on a comparison between the first portion of the polar encoded signal and the second portion of the polar encoded signal. The communications manager 920 is capable of, configured to, or operable to support a means for decoding the set of multiple information bits of the polar encoded signal based on the value of the cell barring bit indicating that the first cell is available for cell attachment.

By including or configuring the communications manager 920 in accordance with examples as described herein, the device 905 may support techniques for reduced latency, reduced power consumption, more efficient utilization of communication resources, improved coordination between devices, improved utilization of processing capability, and the like.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of polar coding techniques for PBCH encoding and transmission as described herein, or the at least one processor 940 and the at least one memory 930 may be otherwise configured to, individually or collectively, perform or support such operations.

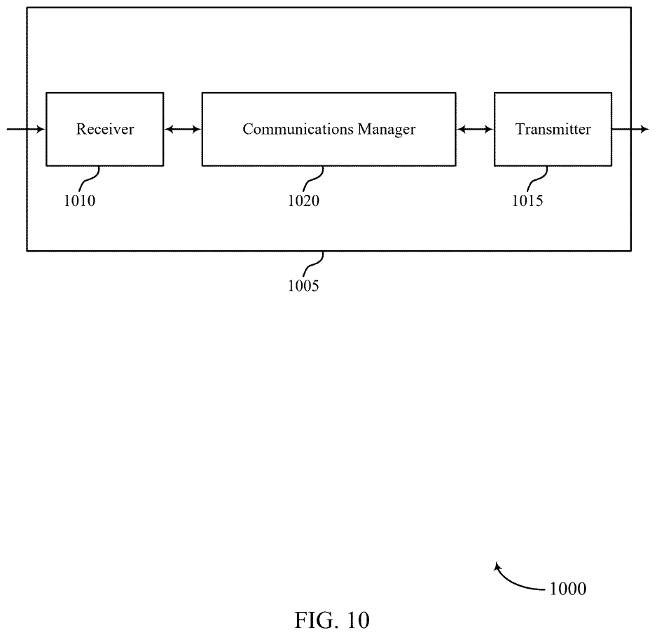

FIG. 10 shows a block diagram 1000 of a device 1005 that supports polar coding techniques for PBCH encoding and transmission in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of polar coding techniques for PBCH encoding and transmission as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for encoding a MIB into a polar encoded signal, the MIB including a set of multiple information bits and a cell barring bit that indicates whether a first cell of the network entity is available for cell attachment, where the polar encoded signal includes a first portion and a second portion. The communications manager 1020 is capable of, configured to, or operable to support a means for transmitting the polar encoded signal based on encoding the MIB. The communications manager 1020 is capable of, configured to, or operable to support a means for performing a cell attachment procedure with a UE based on a value of the cell barring bit indicating that the first cell is available for cell attachment.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for reduced processing, reduced power consumption, more efficient utilization of communication resources, and the like.

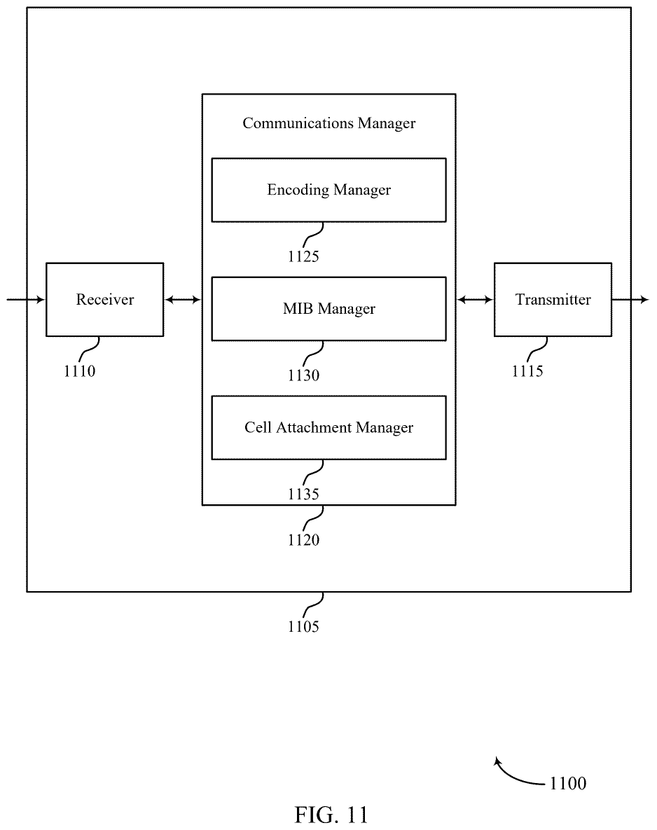

FIG. 11 shows a block diagram 1100 of a device 1105 that supports polar coding techniques for PBCH encoding and transmission in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of polar coding techniques for PBCH encoding and transmission as described herein. For example, the communications manager 1120 may include an encoding manager 1125, a MIB manager 1130, a cell attachment manager 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The encoding manager 1125 is capable of, configured to, or operable to support a means for encoding a MIB into a polar encoded signal, the MIB including a set of multiple information bits and a cell barring bit that indicates whether a first cell of the network entity is available for cell attachment, where the polar encoded signal includes a first portion and a second portion. The MIB manager 1130 is capable of, configured to, or operable to support a means for transmitting the polar encoded signal based on encoding the MIB. The cell attachment manager 1135 is capable of, configured to, or operable to support a means for performing a cell attachment procedure with a UE based on a value of the cell barring bit indicating that the first cell is available for cell attachment.

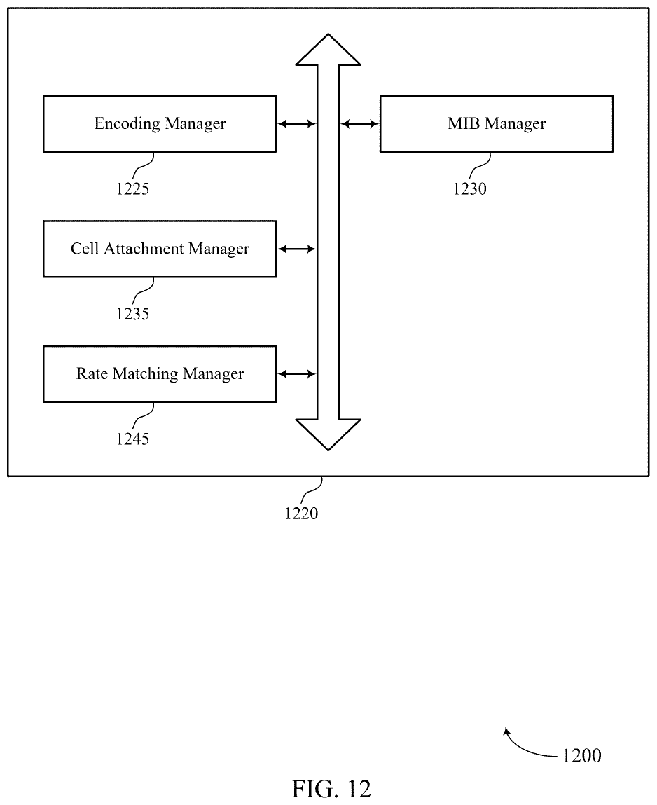

FIG. 12 shows a block diagram 1200 of a communications manager 1220 that supports polar coding techniques for PBCH encoding and transmission in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of polar coding techniques for PBCH encoding and transmission as described herein. For example, the communications manager 1220 may include an encoding manager 1225, a MIB manager 1230, a cell attachment manager 1235, a rate matching manager 1245, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The encoding manager 1225 is capable of, configured to, or operable to support a means for encoding a MIB into a polar encoded signal, the MIB including a set of multiple information bits and a cell barring bit that indicates whether a first cell of the network entity is available for cell attachment, where the polar encoded signal includes a first portion and a second portion. The MIB manager 1230 is capable of, configured to, or operable to support a means for transmitting the polar encoded signal based on encoding the MIB. The cell attachment manager 1235 is capable of, configured to, or operable to support a means for performing a cell attachment procedure with a UE based on a value of the cell barring bit indicating that the first cell is available for cell attachment.

In some examples, the MIB manager 1230 is capable of, configured to, or operable to support a means for generating the MIB in accordance with a MIB format such that that the cell barring bit includes a first bit of the MIB and precedes the set of multiple information bits, where encoding the MIB into the polar encoded signal is based on the MIB format.

In some examples, to support encoding the MIB, the encoding manager 1225 is capable of, configured to, or operable to support a means for encoding the set of multiple information bits based on a first polar code. In some examples, to support encoding the MIB, the encoding manager 1225 is capable of, configured to, or operable to support a means for encoding the cell barring bit based on performing an XOR operation on the second portion of the polar encoded signal and the value of the cell barring bit.

In some examples, the value of the cell barring bit includes a first value that indicates the first cell is available for cell attachment based on the structure of the first portion of the polar encoded signal and the structure of the second portion of the polar encoded signal being the same structure. In some examples, the value of the cell barring bit includes a second value that indicates the first cell is not available for cell attachment based on the structure of the first portion of the polar encoded signal and the structure of the second portion of the polar encoded signal being different.

In some examples, the rate matching manager 1245 is capable of, configured to, or operable to support a means for performing a rate matching procedure for the polar encoded signal, where the rate matching procedure punctures an equal quantity of encoded bits from the first portion of the polar encoded signal and the second portion of the polar encoded signal, and where encoding the set of multiple information bits is based on performing the rate matching procedure.

In some examples, a first channel index associated with the cell barring bit is less than N/2. In some examples, a set of multiple second channel indexes associated with the set of multiple information bits are greater than N/2.

In some examples, the set of multiple information bits include a set of multiple master information block bits and a set of multiple CRC bits.

In some examples, a length of a polar code associated with the polar encoded signal is 1024.

In some examples, the first portion of the polar encoded signal includes a repetition of the second portion of the polar encoded signal or a bitwise complement of the second portion of the polar encoded signal.

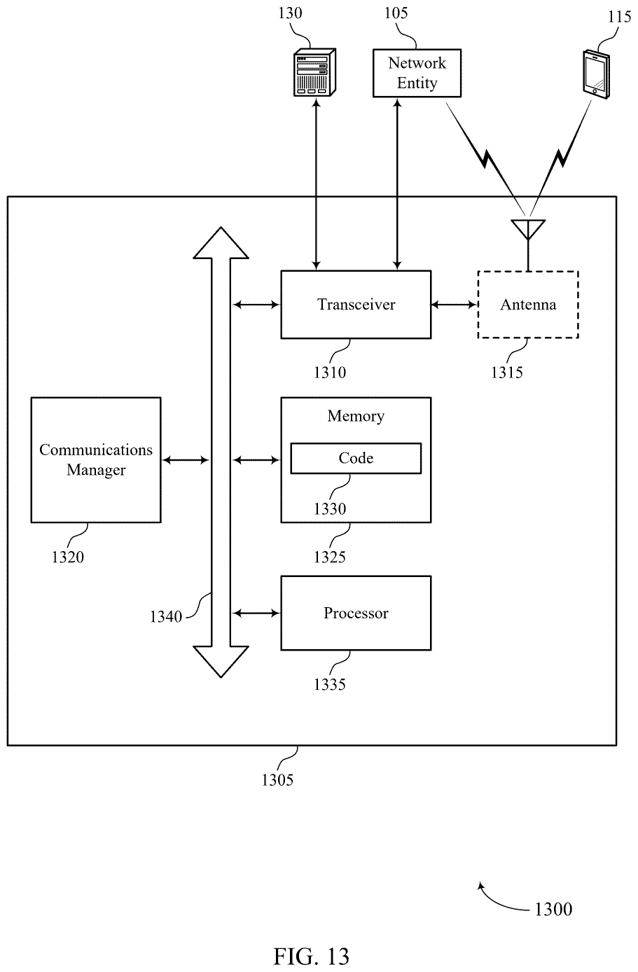

FIG. 13 shows a diagram of a system 1300 including a device 1305 that supports polar coding techniques for PBCH encoding and transmission in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting polar coding techniques for PBCH encoding and transmission). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for encoding a MIB into a polar encoded signal, the MIB including a set of multiple information bits and a cell barring bit that indicates whether a first cell of the network entity is available for cell attachment, where the polar encoded signal includes a first portion and a second portion. The communications manager 1320 is capable of, configured to, or operable to support a means for transmitting the polar encoded signal based on encoding the MIB. The communications manager 1320 is capable of, configured to, or operable to support a means for performing a cell attachment procedure with a UE based on a value of the cell barring bit indicating that the first cell is available for cell attachment.

By including or configuring the communications manager 1320 in accordance with examples as described herein, the device 1305 may support techniques for reduced latency, reduced power consumption, more efficient utilization of communication resources, improved coordination between devices, improved utilization of processing capability, and the like.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of polar coding techniques for PBCH encoding and transmission as described herein, or the at least one processor 1335 and the at least one memory 1325 may be otherwise configured to, individually or collectively, perform or support such operations.

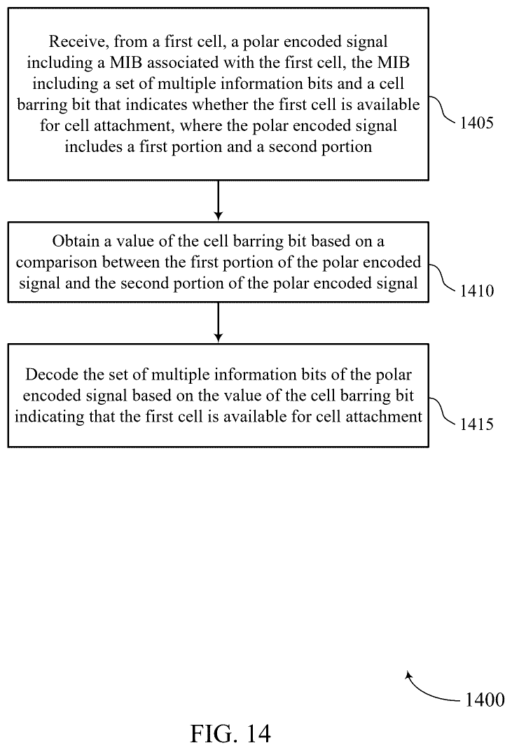

FIG. 14 shows a flowchart illustrating a method 1400 that supports polar coding techniques for PBCH encoding and transmission in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving, from a first cell, a polar encoded signal including a MIB associated with the first cell, the MIB including a set of multiple information bits and a cell barring bit that indicates whether the first cell is available for cell attachment, where the polar encoded signal includes a first portion and a second portion. The operations of 1405 may be performed in accordance with examples as disclosed herein. In some examples, aspects of the operations of 1405 may be performed by a MIB component 825 as described with reference to FIG. 8.

At 1410, the method may include obtaining a value of the cell barring bit based on a comparison between the first portion of the polar encoded signal and the second portion of the polar encoded signal. The operations of 1410 may be performed in accordance with examples as disclosed herein. In some examples, aspects of the operations of 1410 may be performed by a cell barring bit component 830 as described with reference to FIG. 8.

At 1415, the method may include decoding the set of multiple information bits of the polar encoded signal based on the value of the cell barring bit indicating that the first cell is available for cell attachment. The operations of 1415 may be performed in accordance with examples as disclosed herein. In some examples, aspects of the operations of 1415 may be performed by a decoding component 835 as described with reference to FIG. 8.

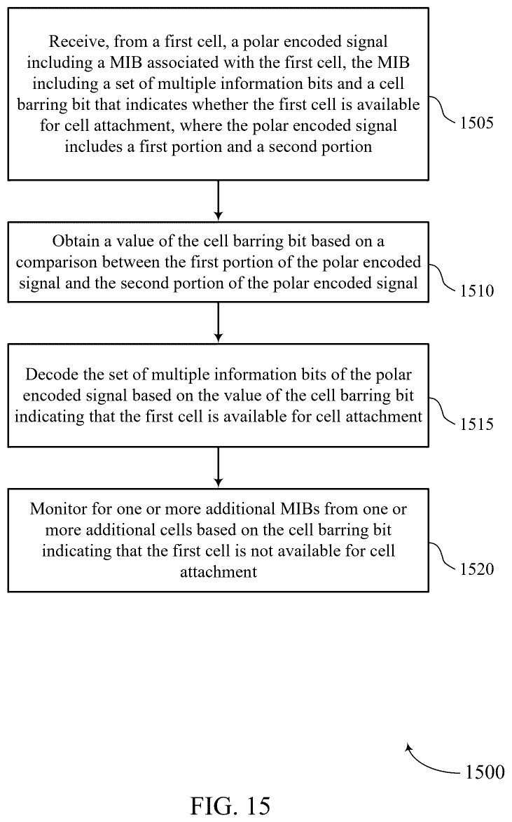

FIG. 15 shows a flowchart illustrating a method 1500 that supports polar coding techniques for PBCH encoding and transmission in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving, from a first cell, a polar encoded signal including a MIB associated with the first cell, the MIB including a set of multiple information bits and a cell barring bit that indicates whether the first cell is available for cell attachment, where the polar encoded signal includes a first portion and a second portion. The operations of 1505 may be performed in accordance with examples as disclosed herein. In some examples, aspects of the operations of 1505 may be performed by a MIB component 825 as described with reference to FIG. 8.

At 1510, the method may include obtaining a value of the cell barring bit based on a comparison between the first portion of the polar encoded signal and the second portion of the polar encoded signal. The operations of 1510 may be performed in accordance with examples as disclosed herein. In some examples, aspects of the operations of 1510 may be performed by a cell barring bit component 830 as described with reference to FIG. 8.

At 1515, the method may include decoding the set of multiple information bits of the polar encoded signal based on the value of the cell barring bit indicating that the first cell is available for cell attachment. The operations of 1515 may be performed in accordance with examples as disclosed herein. In some examples, aspects of the operations of 1515 may be performed by a decoding component 835 as described with reference to FIG. 8.

At 1520, the method may include monitoring for one or more additional MIBs from one or more additional cells based on the cell barring bit indicating that the first cell is not available for cell attachment. The operations of 1520 may be performed in accordance with examples as disclosed herein. In some examples, aspects of the operations of 1520 may be performed by a MIB component 825 as described with reference to FIG. 8.

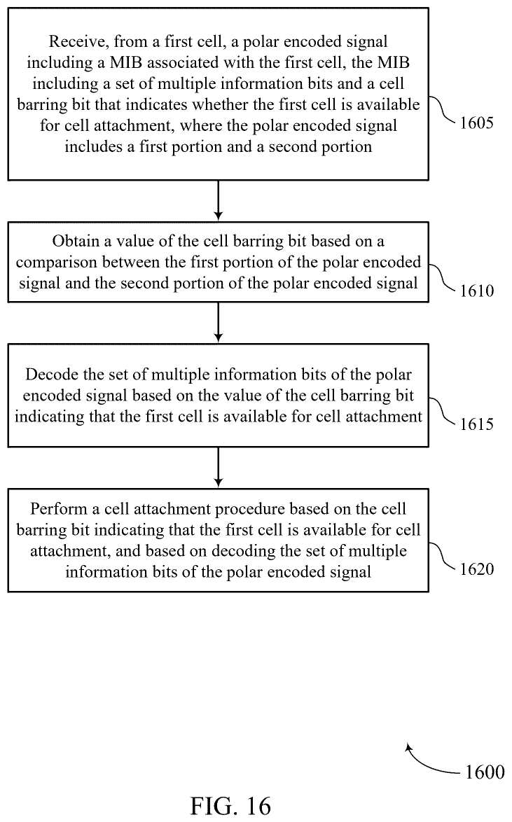

FIG. 16 shows a flowchart illustrating a method 1600 that supports polar coding techniques for PBCH encoding and transmission in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include receiving, from a first cell, a polar encoded signal including a MIB associated with the first cell, the MIB including a set of multiple information bits and a cell barring bit that indicates whether the first cell is available for cell attachment, where the polar encoded signal includes a first portion and a second portion. The operations of 1605 may be performed in accordance with examples as disclosed herein. In some examples, aspects of the operations of 1605 may be performed by a MIB component 825 as described with reference to FIG. 8.

At 1610, the method may include obtaining a value of the cell barring bit based on a comparison between the first portion of the polar encoded signal and the second portion of the polar encoded signal. The operations of 1610 may be performed in accordance with examples as disclosed herein. In some examples, aspects of the operations of 1610 may be performed by a cell barring bit component 830 as described with reference to FIG. 8.

At 1615, the method may include decoding the set of multiple information bits of the polar encoded signal based on the value of the cell barring bit indicating that the first cell is available for cell attachment. The operations of 1615 may be performed in accordance with examples as disclosed herein. In some examples, aspects of the operations of 1615 may be performed by a decoding component 835 as described with reference to FIG. 8.

At 1620, the method may include performing a cell attachment procedure based on the cell barring bit indicating that the first cell is available for cell attachment, and based on decoding the set of multiple information bits of the polar encoded signal. The operations of 1620 may be performed in accordance with examples as disclosed herein. In some examples, aspects of the operations of 1620 may be performed by a cell attachment component 840 as described with reference to FIG. 8.

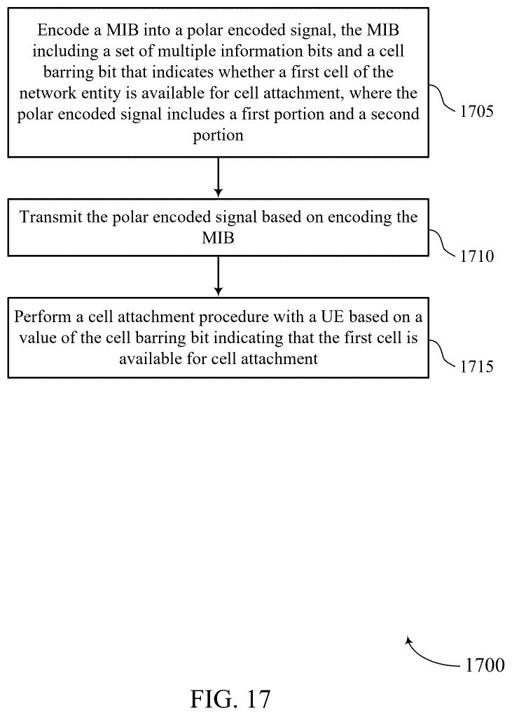

FIG. 17 shows a flowchart illustrating a method 1700 that supports polar coding techniques for PBCH encoding and transmission in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include encoding a MIB into a polar encoded signal, the MIB including a set of multiple information bits and a cell barring bit that indicates whether a first cell of the network entity is available for cell attachment, where the polar encoded signal includes a first portion and a second portion. The operations of 1705 may be performed in accordance with examples as disclosed herein. In some examples, aspects of the operations of 1705 may be performed by an encoding manager 1225 as described with reference to FIG. 12.

At 1710, the method may include transmitting the polar encoded signal based on encoding the MIB. The operations of 1710 may be performed in accordance with examples as disclosed herein. In some examples, aspects of the operations of 1710 may be performed by a MIB manager 1230 as described with reference to FIG. 12.

At 1715, the method may include performing a cell attachment procedure with a UE based on a value of the cell barring bit indicating that the first cell is available for cell attachment. The operations of 1715 may be performed in accordance with examples as disclosed herein. In some examples, aspects of the operations of 1715 may be performed by a cell attachment manager 1235 as described with reference to FIG. 12.

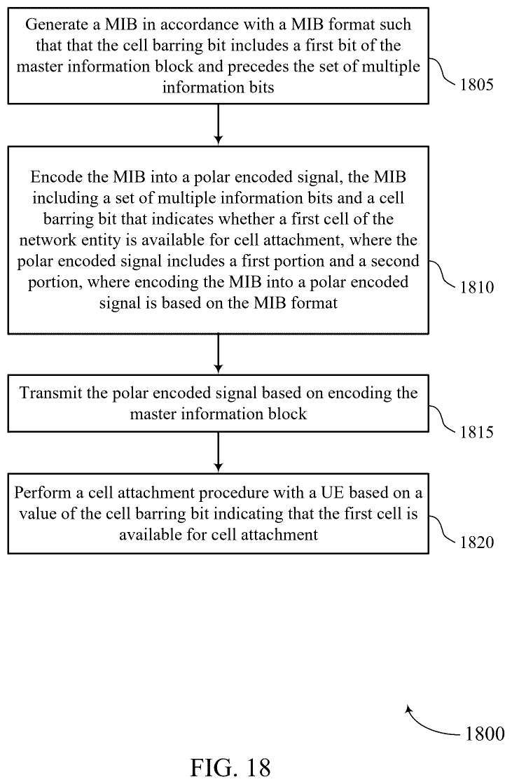

FIG. 18 shows a flowchart illustrating a method 1800 that supports polar coding techniques for PBCH encoding and transmission in accordance with one or more aspects of the present disclosure. The operations of the method 1800 may be implemented by a network entity or its components as described herein. For example, the operations of the method 1800 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1805, the method may include generating a MIB in accordance with a MIB format such that that the cell barring bit includes a first bit of the MIB and precedes the set of multiple information bits. The operations of 1805 may be performed in accordance with examples as disclosed herein. In some examples, aspects of the operations of 1805 may be performed by a MIB manager 1230 as described with reference to FIG. 12.

At 1810, the method may include encoding the MIB into the polar encoded signal, the MIB including a set of multiple information bits and a cell barring bit that indicates whether a first cell of the network entity is available for cell attachment, where the polar encoded signal includes a first portion and a second portion, where encoding the MIB into a polar encoded signal is based on the MIB format. The operations of 1810 may be performed in accordance with examples as disclosed herein. In some examples, aspects of the operations of 1810 may be performed by an encoding manager 1225 as described with reference to FIG. 12.

At 1815, the method may include transmitting the polar encoded signal based on encoding the MIB. The operations of 1815 may be performed in accordance with examples as disclosed herein. In some examples, aspects of the operations of 1815 may be performed by a MIB manager 1230 as described with reference to FIG. 12.

At 1820, the method may include performing a cell attachment procedure with a UE based on a value of the cell barring bit indicating that the first cell is available for cell attachment. The operations of 1820 may be performed in accordance with examples as disclosed herein. In some examples, aspects of the operations of 1820 may be performed by a cell attachment manager 1235 as described with reference to FIG. 12.

The following provides an overview of aspects of the present disclosure:

Aspect 1: A method by a UE, comprising: receiving, from a first cell, a polar encoded signal comprising a MIB associated with the first cell, the MIB comprising a plurality of information bits and a cell barring bit that indicates whether the first cell is available for cell attachment, wherein the polar encoded signal comprises a first portion and a second portion; obtaining a value of the cell barring bit based at least in part on a comparison between the first portion of the polar encoded signal and the second portion of the polar encoded signal; and decoding the plurality of information bits of the polar encoded signal based at least in part on the value of the cell barring bit indicating that the first cell is available for cell attachment.

Aspect 2: The method of aspect 1, further comprising: monitoring for one or more additional MIBs from one or more additional cells based at least in part on the cell barring bit indicating that the first cell is not available for cell attachment.

Aspect 3: The method of aspect 1, further comprising: performing a cell attachment procedure based at least in part on the cell barring bit indicating that the first cell is available for cell attachment, and based at least in part on decoding the plurality of information bits of the polar encoded signal.

Aspect 4: The method of aspect 1, further comprising: refrain from decoding the plurality of information bits of the polar encoded signal based at least in part on the cell barring bit indicating that the first cell is not available for cell attachment.

Aspect 5: The method of any of aspects 1 through 4, wherein the value of the cell barring bit is obtained based at least in part on whether a structure of the first portion of the polar encoded signal and a structure of the second portion of the polar encoded signal are a same structure.

Aspect 6: The method of aspect 5, wherein the value of the cell barring bit comprises a first value that indicates the first cell is available for cell attachment based at least in part on the structure of the first portion of the polar encoded signal and the structure of the second portion of the polar encoded signal being the same structure, and the value of the cell barring bit comprises a second value that indicates the first cell is not available for cell attachment based at least in part on the structure of the first portion of the polar encoded signal and the structure of the second portion of the polar encoded signal being different.

Aspect 7: The method of any of aspects 1 through 6, wherein the polar encoded signal is encoded in accordance with a MIB format such that that the cell barring bit comprises a first bit of the MIB and precedes the plurality of information bits, decoding the plurality of information bits of the MIB is performed based at least in part on the MIB format.

Aspect 8: The method of any of aspects 1 through 7, further comprising: performing a rate de-matching procedure for the polar encoded signal, wherein the rate de-matching procedure punctures an equal quantity of encoded bits from the first portion of the polar encoded signal and the second portion of the polar encoded signal, and wherein the comparison between the first portion of the polar encoded signal and the second portion of the polar encoded signal, decoding the plurality of information bits, or both, is based at least in part on performing the rate de-matching procedure.

Aspect 9: The method of any of aspects 1 through 8, further comprising: performing a cross-correlation between the first portion of the polar encoded signal and the second portion of the polar encoded signal, wherein the comparison comprises the cross-correlation, and wherein decoding the plurality of information bits is based at least in part on a result of the cross-correlation.

Aspect 10: The method of any of aspects 1 through 9, wherein a first channel index associated with the cell barring bit is less than N/2, and a plurality of second channel indexes associated with the plurality of information bits are greater than N/2.

Aspect 11: The method of any of aspects 1 through 10, wherein the plurality of information bits comprise a plurality of MIB bits and a plurality of CRC bits.

Aspect 12: The method of any of aspects 1 through 11, wherein a length of a polar code associated with the polar encoded signal is 1024.

Aspect 13: The method of any of aspects 1 through 12, wherein the first portion of the polar encoded signal comprises a repetition of the second portion of the polar encoded signal or a bitwise complement of the second portion of the polar encoded signal.

Aspect 14: A method by a network entity, comprising: encoding a MIB into a polar encoded signal, the MIB comprising a plurality of information bits and a cell barring bit that indicates whether a first cell of the network entity is available for cell attachment, wherein the polar encoded signal comprises a first portion and a second portion; transmitting the polar encoded signal based at least in part on encoding the MIB; and performing a cell attachment procedure with a UE based at least in part on a value of the cell barring bit indicating that the first cell is available for cell attachment.

Aspect 15: The method of aspect 14, further comprising: generating the MIB in accordance with a MIB format such that that the cell barring bit comprises a first bit of the MIB and precedes the plurality of information bits, wherein encoding the MIB into the polar encoded signal is based at least in part on the MIB format.

Aspect 16: The method of any of aspects 14 through 15, wherein to encoding the MIB further comprises: encoding the plurality of information bits based at least in part on a first polar code; and encoding the cell barring bit based at least in part on performing an XOR operation on the second portion of the polar encoded signal and the value of the cell barring bit.

Aspect 17: The method of any of aspects 14 through 16, wherein the value of the cell barring bit comprises a first value that indicates the first cell is available for cell attachment based at least in part on a structure of the first portion of the polar encoded signal and the structure of the second portion of the polar encoded signal being the same structure, and the value of the cell barring bit comprises a second value that indicates the first cell is not available for cell attachment based at least in part on the structure of the first portion of the polar encoded signal and the structure of the second portion of the polar encoded signal being different.

Aspect 18: The method of any of aspects 14 through 17, further comprising: performing a rate matching procedure for the polar encoded signal, wherein the rate matching procedure punctures an equal quantity of encoded bits from the first portion of the polar encoded signal and the second portion of the polar encoded signal, and wherein encoding the plurality of information bits is based at least in part on performing the rate matching procedure.

Aspect 19: The method of any of aspects 14 through 18, wherein a first channel index associated with the cell barring bit is less than N/2, and a plurality of second channel indexes associated with the plurality of information bits are greater than N/2.

Aspect 20: The method of any of aspects 14 through 19, wherein the plurality of information bits comprise a plurality of MIB bits and a plurality of CRC bits.

Aspect 21: The method of any of aspects 14 through 20, wherein a length of a polar code associated with the polar encoded signal is 1024.

Aspect 22: The method of any of aspects 14 through 21, wherein the first portion of the polar encoded signal comprises a repetition of the second portion of the polar encoded signal or a bitwise complement of the second portion of the polar encoded signal.

Aspect 23: A UE comprising one or more memories storing processor-executable code, and one or more processors coupled with the one or more memories and individually or collectively operable to execute the code to cause the UE to perform a method of any of aspects 1 through 13.

Aspect 24: A UE comprising at least one means for performing a method of any of aspects 1 through 13.

Aspect 25: A non-transitory computer-readable medium storing code the code comprising instructions executable by one or more processors to perform a method of any of aspects 1 through 13.

Aspect 26: A network entity comprising one or more memories storing processor-executable code, and one or more processors coupled with the one or more memories and individually or collectively operable to execute the code to cause the network entity to perform a method of any of aspects 14 through 22.

Aspect 27: A network entity comprising at least one means for performing a method of any of aspects 14 through 22.

Aspect 28: A non-transitory computer-readable medium storing code the code comprising instructions executable by one or more processors to perform a method of any of aspects 14 through 22.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, from a first cell, a polar encoded signal comprising a master information block associated with the first cell, the master information block comprising a plurality of information bits and a cell barring bit that indicates whether the first cell is available for cell attachment, wherein the polar encoded signal comprises a first portion and a second portion;
obtain a value of the cell barring bit based at least in part on a comparison between the first portion of the polar encoded signal and the second portion of the polar encoded signal; and
decode the plurality of information bits of the polar encoded signal based at least in part on the value of the cell barring bit indicating that the first cell is available for cell attachment.

2. The UE of claim 1, wherein the one or more processors are individually or collectively further operable to execute the code to cause the UE to:
monitor for one or more additional master information blocks from one or more additional cells based at least in part on the cell barring bit indicating that the first cell is not available for cell attachment.

3. The UE of claim 1, wherein the one or more processors are individually or collectively further operable to execute the code to cause the UE to:
perform a cell attachment procedure based at least in part on the cell barring bit indicating that the first cell is available for cell attachment, and based at least in part on decoding the plurality of information bits of the polar encoded signal.

4. The UE of claim 1, wherein the one or more processors are individually or collectively further operable to execute the code to cause the UE to:
refrain from decoding the plurality of information bits of the polar encoded signal based at least in part on the cell barring bit indicating that the first cell is not available for cell attachment.

5. The UE of claim 1, wherein the value of the cell barring bit is obtained based at least in part on whether a structure of the first portion of the polar encoded signal and a structure of the second portion of the polar encoded signal are a same structure.

6. The UE of claim 5, wherein:
the value of the cell barring bit comprises a first value that indicates the first cell is available for cell attachment based at least in part on the structure of the first portion of the polar encoded signal and the structure of the second portion of the polar encoded signal being the same structure, and
the value of the cell barring bit comprises a second value that indicates the first cell is not available for cell attachment based at least in part on the structure of the first portion of the polar encoded signal and the structure of the second portion of the polar encoded signal being different.

7. The UE of claim 1, wherein the polar encoded signal is encoded in accordance with a master information block format such that that the cell barring bit comprises a first bit of the master information block and precedes the plurality of information bits, wherein decoding the plurality of information bits of the master information block is performed based at least in part on the master information block format.

8. The UE of claim 1, wherein the one or more processors are individually or collectively further operable to execute the code to cause the UE to:
perform a rate de-matching procedure for the polar encoded signal, wherein the rate de-matching procedure punctures an equal quantity of encoded bits from the first portion of the polar encoded signal and the second portion of the polar encoded signal, and wherein the comparison between the first portion of the polar encoded signal and the second portion of the polar encoded signal, decoding the plurality of information bits, or both, is based at least in part on performing the rate de-matching procedure.

9. The UE of claim 1, wherein the one or more processors are individually or collectively further operable to execute the code to cause the UE to:
perform a cross-correlation between the first portion of the polar encoded signal and the second portion of the polar encoded signal, wherein the comparison comprises the cross-correlation, and wherein decoding the plurality of information bits is based at least in part on a result of the cross-correlation.

10. The UE of claim 1, the cell barring bit and the plurality of information bits are jointly encoded using a polar code of length N, wherein:
a first channel index associated with the cell barring bit is less than N/2, and
a plurality of second channel indexes associated with the plurality of information bits are greater than N/2.

11. The UE of claim 1, wherein the plurality of information bits comprise a plurality of master information block bits and a plurality of cyclic redundancy check bits.

12. The UE of claim 1, wherein a length of a polar code associated with the polar encoded signal is 1024.

13. The UE of claim 1, wherein the first portion of the polar encoded signal comprises a repetition of the second portion of the polar encoded signal or a bitwise complement of the second portion of the polar encoded signal.

14. A network entity, comprising:
one or more memories storing processor-executable code; and
one or more processors coupled with the one or more memories and individually or collectively operable to execute the code to cause the network entity to:
encode a master information block into a polar encoded signal, the master information block comprising a plurality of information bits and a cell barring bit that indicates whether a first cell of the network entity is available for cell attachment, wherein the polar encoded signal comprises a first portion and a second portion;
transmit the polar encoded signal based at least in part on encoding the master information block; and
perform a cell attachment procedure with a user equipment (UE) based at least in part on a value of the cell barring bit indicating that the first cell is available for cell attachment.

15. The network entity of claim 14, wherein the one or more processors are individually or collectively further operable to execute the code to cause the network entity to:
generate the master information block in accordance with a master information block format such that that the cell barring bit comprises a first bit of the master information block and precedes the plurality of information bits, wherein encoding the master information block into the polar encoded signal is based at least in part on the master information block format.

16. The network entity of claim 14, wherein, to encode the master information block, the one or more processors are individually or collectively further operable to execute the code to cause the network entity to:
encode the plurality of information bits based at least in part on a first polar code; and
encode the cell barring bit based at least in part on performing an xor operation on the second portion of the polar encoded signal and the value of the cell barring bit.

17. The network entity of claim 14, wherein:
the value of the cell barring bit comprises a first value that indicates the first cell is available for cell attachment based at least in part on a structure of the first portion of the polar encoded signal and the structure of the second portion of the polar encoded signal being a same structure, and
the value of the cell barring bit comprises a second value that indicates the first cell is not available for cell attachment based at least in part on the structure of the first portion of the polar encoded signal and the structure of the second portion of the polar encoded signal being different.

18. The network entity of claim 14, wherein the one or more processors are individually or collectively further operable to execute the code to cause the network entity to:
perform a rate matching procedure for the polar encoded signal, wherein the rate matching procedure punctures an equal quantity of encoded bits from the first portion of the polar encoded signal and the second portion of the polar encoded signal, and wherein encoding the plurality of information bits is based at least in part on performing the rate matching procedure.

19. The network entity of claim 14, wherein the cell barring bit and the plurality of information bits are jointly encoded using a polar code of length N, wherein:
a first channel index associated with the cell barring bit is less than N/2, and
a plurality of second channel indexes associated with the plurality of information bits are greater than N/2.

20. The network entity of claim 14, wherein the plurality of information bits comprise a plurality of master information block bits and a plurality of cyclic redundancy check bits.

21. The network entity of claim 14, wherein a length of a polar code associated with the polar encoded signal is 1024.

22. The network entity of claim 14, wherein the first portion of the polar encoded signal comprises a repetition of the second portion of the polar encoded signal or a bitwise complement of the second portion of the polar encoded signal.

23. A method for wireless communications at a user equipment (UE), comprising:
receiving, from a first cell, a polar encoded signal comprising a master information block associated with the first cell, the master information block comprising a plurality of information bits and a cell barring bit that indicates whether the first cell is available for cell attachment, wherein the polar encoded signal comprises a first portion and a second portion;
obtaining a value of the cell barring bit based at least in part on a comparison between the first portion of the polar encoded signal and the second portion of the polar encoded signal; and
decoding the plurality of information bits of the polar encoded signal based at least in part on the value of the cell barring bit indicating that the first cell is available for cell attachment.

24. The method of claim 23, further comprising:
monitoring for one or more additional master information blocks from one or more additional cells based at least in part on the cell barring bit indicating that the first cell is not available for cell attachment.

25. The method of claim 23, further comprising:
performing a cell attachment procedure based at least in part on the cell barring bit indicating that the first cell is available for cell attachment, and based at least in part on decoding the plurality of information bits of the polar encoded signal.

26. The method of claim 23, further comprising:
refraining from decoding the plurality of information bits of the polar encoded signal based at least in part on the cell barring bit indicating that the first cell is not available for cell attachment.

27. The method of claim 23, wherein the polar encoded signal is encoded in accordance with a master information block format such that that the cell barring bit comprises a first bit of the master information block and precedes the plurality of information bits, wherein decoding the plurality of information bits of the master information block is performed based at least in part on the master information block format.

28. A method for wireless communications at a network entity, comprising:
encoding a master information block into a polar encoded signal, the master information block comprising a plurality of information bits and a cell barring bit that indicates whether a first cell of the network entity is available for cell attachment, wherein the polar encoded signal comprises a first portion and a second portion;
transmitting the polar encoded signal based at least in part on encoding the master information block; and
performing a cell attachment procedure with a user equipment (UE) based at least in part on a value of the cell barring bit indicating that the first cell is available for cell attachment.

29. The method of claim 28, further comprising:
generating the master information block in accordance with a master information block format such that that the cell barring bit comprises a first bit of the master information block and precedes the plurality of information bits, wherein encoding the master information block into the polar encoded signal is based at least in part on the master information block format.

30. The method of claim 28, wherein encoding the master information block further comprises:
encoding the plurality of information bits based at least in part on a first polar code; and
encoding the cell barring bit based at least in part on performing an xor operation on the second portion of the polar encoded signal and the value of the cell barring bit.
